(19) United States
(12) Patent Application Publication
(10) Pub. No.: US 2021/0383540 A1
(43) Pub. Date: Dec. 9, 2021

(54) PARTIAL VOLUME ESTIMATION FROM SURFACE RECONSTRUCTIONS

(71) Applicant: Oxford University Innovation Limited, Oxford (GB)

(72) Inventors: Thomas KIRK, Oxford (GB); Michael CHAPPELL, Oxford (GB)

(21) Appl. No.: 17/330,518

(22) Filed: May 26, 2021

Related U.S. Application Data
(60) Provisional application No. 63/013,712, filed on Apr. 22, 2020.

(51) Int. Cl. G06T 7/00; G06T 7/73

(52) U.S. Cl. CPC G06T 7/0014; G06T 7/74; G06T 2207/10104; G06T 2207/20021; G06T 2207/30016; G06T 2207/10088

(57) ABSTRACT

Described herein are methods and systems for partial volume estimation (PVE) and correction of PVE of imaging data acquired or provided of a subject, The imaging data can include functional imaging data, in particular functional imaging data acquired using magnetic resonance (MR), arterial spin labeling (ASL), blood-oxygen level dependent (BOLD) magnetic resonance imaging (MRI), or positron emission tomography (PET) of the subject.

### CROSS-REFERENCE TO RELATED APPLICATION

This application claims the benefit of and priority to U.S. Provisional Patent Application No. 63/013,712 filed Apr. 22, 2020, which is entirely incorporated herein by reference.

### TECHNICAL FIELD

The present disclosure generally relates to methods and systems for imaging of complex structures, in particular for partial volume estimation of surfaces derived from imaging data and correction thereof, and more particularly from cortical surface reconstructions in magnetic resonance imaging.

### BACKGROUND

Partial volume effects (PVE) present a source of confound for imaging data and the analysis thereof, for example functional imaging data. Correction for PVE requires estimates of the partial volumes (PVs) present in an image. These estimates are conventionally obtained via volumetric segmentation, but such an approach may not be accurate for complex structures, e.g., structures having complex geometries, such as the cerebral cortex. Accordingly, there is a need to address the aforementioned deficiencies and inadequacies. New methods and systems to estimate partial volumes and using the estimated partial volumes correct or improve imaging of complex structures through correction of PVE are therefore desired.

### SUMMARY

The present disclosure is directed to improving imaging quality, in particular when imaging complex structures, and the correction of partial volume effects (PVE) in imaging data, for example in magnetic resonance imaging data, functional magnetic resonance imaging data (such as arterial spin labeling, ASL) data, or imaging data acquired via other functional imaging modalities. The present disclosure provides new methods and systems for estimating partial volumes present in the imaging data using surfaces of structures derived from the imaging data to estimate the partial volumes, which partial volume estimates can then be used to correct for PVE in the imaging data. It has particular application to cortical volume estimation from imaging data, though not limited to such.

In an embodiment, a method is provided. The method can provide a means for determining or estimating partial volumes (PVs) in imaging data for correction of partial volume effects in the imaging data and reconstruction of corrected image data. In an embodiment, the method comprises: providing or having provided surfaces derived from imaging data from a subject; setting a reference grid comprised of a plurality of voxels within the imaging data; mapping the surfaces into the reference grid; identifying and recording local patches of the surfaces intersecting each voxel of the reference grid; subdividing one or more of the voxels into one or more subvoxels by a first subdivision factor; processing the one or more subvoxels to determine their partial volumes arising from intersection of at least one of the surfaces by assigning a class volume, wherein assigning a class volume comprises determining if a subvoxel intersects at least one of the surfaces, wherein: if it does not intersect at least one of the surfaces, assigning a single class volume, or if the subvoxel intersects one of the surfaces, estimating an interior or exterior partial volume of the subvoxel and determining the estimated interior or exterior volume by subtracting the estimated volume from the total subdivided voxel volume, or if the one of the surfaces is folded within the subvoxel or intersects the subvoxel more than once, then subdividing the subvoxel with a second subdivision factor and assigning a single tissue class volume to the subdivided subvoxel, combining the partial volumes of each individual subvoxel and subdivided subvoxel; and reconstructing an image from the combined partial volumes.

In any one or more aspects of any one or more embodiments of the method, the subject can be an animate or an inanimate subject. The imaging data of the subject can include surfaces having complex structures, such as structures having complex geometries. The subject can an animal, such as a human subject. The imaging data can be functional imaging data, such as magnetic resonance data, arterial spin labeling (ASL) data, blood-oxygen level dependent (BOLD) magnetic resonance imaging (MRI) data, and/or positron emission tomography (PET) data. The estimating an interior or exterior partial volume of the subvoxel can be with a convex hull. Determining the estimated interior or exterior volume can be with a non-convex hull by subtracting the convex hull estimated volume from the total subdivided voxel volume. The identifying and recording step can involve use of a separating axis theorem, for example Moller's Box-overlap test. The first subdivision factor can convert an anisotropic voxel to an isotropic voxel. The first subdivision factor can be ceil (v/0.75) where v is the vector of voxel dimensions and 0.75 represents the lower limit of feature size found in a brain. The subject surface can comprise one or more of white matter (WM), grey matter (GM), and cerebrospinal fluid (CSF). The second subdivision factor can be 5. The method can further comprise acquiring the imaging data by providing a subject and positioning the subject in relation to an imaging scanner after providing the subject before providing the imaging data. The imaging scanner can be a medical imaging scanner, such as a magnetic resonance imaging (MRI) or positron emission tomography (PET) scanner. The method can further comprise correcting the partial volumes. The correcting of the partial volumes can be performed using spatialVB. The method can further comprise outputting the reconstructed image to an imaging display.

In an embodiment, a system is provided. The system can acquire or have acquired imaging data of a subject wherein surface data is derived from the imaging data or is provided to the system. The system can comprise an imaging scanner and at least one computing device in data communication with the imaging scanner; and an application executable in the at least one computing device, the application comprising logic that when executed on the computing device, executes any one or more or all of the aforementioned features of any one or more embodiments of the method in any combination. The imaging scanner can be a medical imaging scanner, such as a magnetic resonance imaging (MRI) or positron emission tomography (PET) scanner.

In an embodiment, a non-statutory computer readable medium is provided. The medium can employ a program executable in at least one computing device comprising code that can carry out any one or more or all of the aforementioned features of any one or more embodiments of the system or method, in any combination.

Other methods, systems, features, and advantages of the present disclosure for partial volume estimation from cortical surface reconstructions will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a flowchart of an embodiment of a method as described herein.

FIG. 2 shows an embodiment of a computing device or apparatus 1010 that can be implemented in the systems as described herein and which can implement methods as described herein.

FIG. 3 is a graphic depicting a reduced ray intersection test for non-contiguous surfaces. The root point (interior) is shown in magenta. A ray from an interior point (green) makes two intersections due to the presence of a fold; from an exterior point (yellow) there is one intersection.

FIG. 4 shows the intersection of inner (magenta) and outer (green) surfaces of the cortex within a voxel. In the example shown, the outer surface intersects twice with distinct patches of surface; this is likely due to the presence of a sulcus. Tissue partial volumes (PVs) are labelled—grey matter (GM), white matter (WM), and non-brain.

FIGS. 5A-5F illustrate various subvoxel/surface configurations. FIG. 5A shows no intersection: whole-volume assignment; FIG. 5B shows single intersection through one face: a small convex hull will be formed; FIGS. 5C-5D show two examples, respectively, of single intersection, folded surface: further subdivision will be used; FIG. 5E shows an example when there is a single intersection through multiple faces: a convex hull will be formed; FIG. 5F shows multiple surface intersection (unconnected patches of surface, likely a sulcus): further subdivision will be used.

FIGS. 6A-6B are a render of an illustrative example. FIG. 6A shows simulated surfaces; FIG. 6B is a cutaway showing inner (red) and outer (green) surfaces. Peak radial distance between the two in the present example was 3 mm.

FIGS. 7A-7B are graphs depicting error in total tissue volume of simulated surfaces. The present Toblerone showed consistency, though with small bias, for both (GM) and (WM). Ribbon-constrained 1 (RC1) errors were lower for GM than WM. Resampling-based methods (ribbon-constrained 2 (RC2) Neuro2) showed particular consistency in WM. Additional results shown in FIGS. 15A-15B.

FIGS. 8A-8B are graphs depicting per-voxel error of simulated surfaces. Toblerone and RC produced the lowest errors in GM; in WM there was a clear difference to Toblerone. RC2 and Neuro2's errors both decreased with increasing voxel size, with a characteristic notch observed at 2 mm. Additional results shown in FIGS. 16A-16B.

FIGS. 9A-9B illustrate BrainWeb: difference in total tissue volume referenced to each method's 0% noise 0% NU result. Surface-based methods were more consistent at almost all noise and NU levels; FAST was more consistent in GM (FIG. 9A) than WM (FIG. 9B).

FIGS. 10A-10B show BrainWeb: root-mean squared (RMS) per-voxel differences at 3 mm voxel size for GM (FIG. 10A) and (FIG. 10B), referenced to each method's 1 mm 0% noise 0% NU results. Toblerone's differences were smaller at almost all levels of noise and NU, as was also the case at other voxel sizes. Additional results for other voxel sizes shown in FIGS. 17A-17H.

FIG. 11 is a graph illustrating Human Connectome Project (HCP) test-retest: mean difference between Toblerone and FAST GM PVs, sorted into 5% width bins according to Toblerone's GM PV. As Toblerone's GM PV estimate in a given voxel increased, FAST was more likely to assign a smaller value, and vice-versa. The strength of this relationship decreased with increasing voxel size. An inverse, but weaker, effect was seen for WM (see also FIG. 18).

FIG. 12 is a plot of HCP test-retest: inter-session (retest minus test) difference in total tissue volume. PVs were estimated in the native 0.7 mm isotropic space of the structural images. RC's result is for the cortex only. Both surface methods show a tighter distribution than FAST.

FIG. 13 is a graph depicting simulated surfaces: error induced by resampling the ground truth GM PV map, masked to voxels intersecting either surface of the cortex. As the input voxel size increases, error increases, but as the ratio output/input voxel size increases, error falls. Finally, error falls to zero when the ratio takes an integer value.

FIGS. 14A-14D depict Illustration of resampling-induced blurring on the 1 mm isotropic GM PV map from the 0% noise 0% NU BrainWeb image. The left column shows the original estimates produced by FAST and Toblerone, the right shows the result of a 0.5 mm translation along each axis. The left thalamus (red) and right putamen (blue) are highlighted in each, showing how surface and volumetric methods differ markedly in their interpretation of subcortical structures (FAST does not regard them as pure GM, whereas Toblerone does for the analyses presented in this work).

FIGS. 15A-15B are graphs showing simulated surfaces: error in total tissue volume (GM, FIG. 15A; WM, FIG. 15B), all methods. The notch in the Neuro method at 2 mm may arise due to an interplay between the number of expanded surfaces created (5) and the voxel size.

FIGS. 16A-16B are graphs showing simulated surfaces: RMS per-voxel error in GM (FIG. 16A) and WM (FIG. 16B). Neuro's results are significantly worse than all other methods at all other resolutions, though the resampled version (Neuro2) performs better.

FIGS. 17A-17H are plots showing BrainWeb: RMS per-voxel differences at voxel sizes of 1 to 4 mm isotropic GM (FIGS. 17A-17D) and WM (FIGS. 17E-17H), referenced to each method's 1 mm 0% noise 0% NU results. Toblerone's differences were smaller at almost all levels of noise and NU, the exception being 0% noise.

FIG. 18 is a graph showing HCP test-retest: mean difference between Toblerone and FAST WM PVs, sorted into 5% width bins according to Toblerone's GM PV. This is the analogue of FIG. 11, showing a weaker and inverse relationship.

FIGS. 19A-19C show an overview of an embodiment of methods according to the present disclosure. FIG. 19A is an embodiment of a surface-based pipeline for estimating PVs in neuro context; FIG. 19B depicts WM/GM (pink) and GM/CSF (green) surface boundaries of the cortex intersecting a voxel in accordance with an embodiment of the present Toblerone method for PV estimation; and FIG. 19C is an ASL perfusion image with PVEc performed using Toblerone surface estimates.

FIGS. 20A-20C are graphs showing simulated surfaces, standard deviation of voxel-wise error across resolutions for grey matter (GM, FIG. 20A), white matter (WM, FIG. 20A), and non-brain (FIG. 20C).

FIG. 21 is a graph of HCP surfaces, mean per-subject difference in total tissue volume between resolutions in GM.

FIG. 22 is a graph of HCP surfaces, mean per-subject difference in total tissue volume between resolutions in WM.

FIG. 23 is a graph depicting Mean difference (Toblerone-FAST) in per-acquisition PVE-corrected mean tissue perfusion.

FIGS. 24A-24C are cerebral blood-flow images, showing an example of an ASL perfusion image from the multi-PLD dataset, with either no PVEc (FIG. 24A), or PVEc applied using FAST (FIG. 24B) and Toblerone (FIG. 24C).

FIGS. 25A-25B are graphs showing mean difference (Toblerone-FAST) in per-acquisition PVE-corrected mean tissue perfusion.

FIGS. 26A-26C are graphs of Simulation results: standard deviation of voxel-wise error. Toblerone estimates had the lowest, or close to lowest, std. dev. of voxel-wise error in all tissue types (GM, FIG. 26A; WM, FIG. 26B; and non-brain, FIG. 26C) at all resolutions, particularly in WM and non-brain.

FIGS. 27A-27C are graphs showing HCP results, mean across subjects of standard deviation in voxel-wise difference to Toblerone's estimate (GM, FIG. 27A; WM, FIG. 27B; and non-brain, FIG. 27C). The differences between RC1/RC2 (surface-based methods) and Toblerone were comparable to those in the simulations, which suggested that the surface-based methods were behaving consistently on the simulations as on the HCP data. The voxel-wise differences between FAST and Toblerone were much more significant at all resolutions (e.g. 14% standard deviation of difference at 3 mm in GM).

FIGS. 28A-28C are graphs showing HCP results, mean across subjects of difference in total estimated tissue volume to Toblerone (GM, FIG. 28A; WM, FIG. 28B; and non-brain, FIG. 28C). All methods showed agreement at small voxel sizes but FAST in particular diverged with increasing size. Along with the results in FIGS. 27A-27C, this suggests that FAST and Toblerone broadly agreed on overall tissue volume at fine resolutions but disagreed on its distribution across voxels. As PVEc is a voxel-wise operation that is sensitive to error in PV estimates [1], these differences will have implications for PVEc.

FIGS. 29A-29C are PV estimates for subject 100307 of the HCP at 1.4 mm isotropic resolution in GM (L, FIG. 29A), WM (C, FIG. 29B) and non-brain (R, FIG. 29C).

FIG. 30 is an example of a simple voxel. There is no intersection, so the whole subvoxel is assigned (WM in this example).

FIGS. 31A-31B are additional examples of simple voxels. One surface intersection->convex hull algorithm to find the V1, then do V2=1−V1 to get the other side.

FIG. 32 provides another simple example. One intersection of each surface->use convex hulls twice and then V3=V−V1−V2.

FIG. 33 provides a complicated example. High curvature of the surface (i.e., a fold within the subvoxel)->use recursion again.

FIGS. 34A-34B show another complicated example. Multiple intersections of the same surface are too complex->use recursion again.

FIG. 35 The ray intersection test used in Toblerone, applied to a sinusoidally varying surface (the underside of the surface is interior). The yellow point is the root point (a point known to be interior to the surface) and the green point the point under test. The ray projected between them is shown in red. In this case, two intersections are recorded; along the direction of travel from green to yellow they are respectively a point of exit and a point of entry to the surface: the green point is therefore classified as interior.

FIGS. 36A-36F Various subvoxel/surface configurations. The inner surface is shown in magenta, the outer in green, the voxel as a box with green edges and blue vertices. FIG. 36A: No intersection with either surface: whole-tissue assignment (GM); FIG. 36B: single intersection with a surface: two-tissue quantification with convex hull (GM and WM); FIG. 36C: two surfaces, each with a single intersection: quantification of WM and CSF with convex hulls and GM as the remainder; FIG. 36D: a single surface folded within the subvoxel: recursion will be used; FIG. 36E: the banks of a sulcus give rise to multiple surface intersections, the orange arrow denotes the plane along which the banks are adjacent, the magenta arrows show the point at which they diverge: recursion will again be used (GM and CSF); FIG. 36F: the same as in (FIG. 36E) shown from a different point of view.

FIGS. 37A-37B depict surface phantoms: sines (FIG. 37A) and bumpy spheres (FIG. 37B), both at normal surface resolution (˜0.85 mm node spacing). The inner surface is red, the outer green; the inner cannot be seen in the bumpy sphere because it is enclosed. Axes are in units of mm.

FIGS. 38A-38B are 1D illustration of subvoxel effects when resampling from 1 mm to 1.4 mm (FIG. 38A) and 3.4 mm (FIG. 38B) voxels. The span of the new voxel is shown within the orange lines in each case. Each 1 mm shares the same spatial distribution of tissues, 70% GM (shaded blue) and 30% WM (unshaded). The difference between the true and resampled GM PV is reduced as the new voxel size increases.

### DETAILED DESCRIPTION

Described below are methods for partial volume estimation from cortical surface reconstructions. Although particular embodiments are described, those embodiments are mere exemplary implementations of the system and method. One skilled in the art will recognize other embodiments are possible. All such embodiments are intended to fall within the scope of this disclosure. Moreover, all references cited herein are intended to be and are hereby incorporated by reference into this disclosure as if fully set forth herein. While the disclosure will now be described in reference to the above drawings, there is no intent to limit it to the embodiment or embodiments disclosed herein. On the contrary, the intent is to cover all alternatives, modifications and equivalents included within the spirit and scope of the disclosure.

### Discussion

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

It is to be understood that, unless otherwise indicated, the present disclosure is not limited to particular types of methods and systems relating to partial volume estimation from cortical surface reconstructions, and particular software[s] for post-processing and analysis, or the like, as such can vary. It is also to be understood that the terminology used herein is for purposes of describing particular embodiments only and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a scanner” includes a plurality of scanners. In this specification and in the claims that follow, reference will be made to a number of terms that shall be defined to have the following meanings unless a contrary intention is apparent.

### Description

In research and clinical imaging, image reconstruction of complex structures is often performed by first obtaining partial volume (PV) estimates of a structure of interest. If the resolution of the image or imaging matrix is coarse compared to the underlying structural or anatomical details of desire, for example having low spatial resolution in relation to the structures of interest within the image, partial volume effects (PVE) arise. This can be common for functional imaging techniques such as positron emission tomography (PET), blood oxygen-level dependent fMRI (BOLD) and arterial spin labelling (ASL). Such partial volume effects can then be corrected for, and the signal within a voxel de-mixed to determine the contribution of various tissue types to the signal as a whole.

Although surface-based PV estimation tools exist in the literature for correction of PVE, past efforts have usually been designed with a specific modality in mind. Two notable examples for neuroimaging are the ribbon-constrained (RC) method used within the Human Connectome Project's (HCP) fMRISurface pipeline and PETSurfer a variant of FreeSurfer. The former is designed for use with BOLD and so distinguishes only between cortex and otherwise, not the grey matter (GM), white matter (WM) and non-brain required for ASL and PET; whereas the latter is both PET-specific and tightly integrated into FreeSurfer such that it is hard to use independently of that workflow. Furthermore, both methods deal exclusively with surfaces representing the cortex.

Partial volume effects (PVE) continue to present a source of confound for functional imaging: whilst the objective is to obtain a measurement of function across some particular structure, the signal actually measured in each voxel is a sum, weighted by the partial volumes, of function both within and without said structure. This is a mixed-source problem in which the multiple tissues in each voxel constitute the sources. Partial volume effect correction (PVEc) uses voxel-wise estimates of PVs to separate out the signal arising from each tissue. Various PVEc methods have been developed, usually with a specific modality in mind (for example, Muller-Gartner for PET and linear regression or spatially-regularized variational Bayes for ASL). These methods have drawbacks such as those described below and elsewhere herein.

Provided herein are systems and methods of partial volume estimation[s] from surface representations of complex structures, that can be used for the partial volume correction of imaging data acquired from multiple modalities. The complex structures can include, but are not limited to, the cerebral cortex, both cortical and subcortical structures (where such structures are available), and other anatomical structures that may be segmented by a surface. In various embodiments, systems and methods of partial volume estimation[s] from cortical surface reconstructions relating to imaging are provided, for example magnetic resonance (MR) imaging, of a subject. In various aspects, the subject can be a human patient.

In certain aspects, methods and systems as described herein addresses PV estimation for structures within the brain, for which the tissue classes of interest are GM, WM and non-brain. The same principles can apply to structures in other areas of the body, though the interpretation of tissue classes would differ, and apply to other modalities of imaging (positron emission tomography, for example).

Correction for PVE first requires estimates of the partial volumes (PVs) present in an image or acquired image data. These estimates are conventionally obtained via volumetric segmentation, but such an approach may not be accurate for complex structures such as the cortex. An alternative is to use surface-based segmentation, which is well-established within the literature. However, prior surface-based segmentation methods do not involve the notion of projecting volumetric data onto the cortical surface prior to analysis as described by systems and methods herein. Generally they derive estimates on one grid and leave the user to then transform those on to another grid, with associated errors introduced.

In certain aspects, systems and methods described herein are new utilities for estimating PVs using such surfaces utilizing a heavily modified ray intersection test adapted from the computer graphics literature. Such heavily modified ray intersection not only performs less comparisons than necessary for traditional computer graphics applications but also interprets the data in a different way, thus requiring less image data processing and providing efficiencies in the image data processing and improved imaging of complex structures.

In various embodiments escribed herein are purely geometric approaches that consider the intersection between a surface and the voxels of an image. Being a purely geometric question, namely, given a pair of surfaces that intersect a voxel and what is the volume bounded by each that is contained within voxel, this is a fundamentally different approach to existing methods. Such a fundamentally different approach provides improvements in imaging as it: lends for the relaxing of constraints present in prior approaches as the present approaches are not limited to a particular imaging modality or subcutaneous anatomical structure; is less resource intensive and provides for reduction in image processing and image processing time; and provides for more accurate images.

In a particular aspect, systems and methods as described herein improve on existing techniques for partial volume estimation, such as the ribbon constrained (RC) method, as systems and methods as described herein are not limited to the cortex only and can investigate sub-cortical structures; systems and methods as described herein work with more than two surfaces (ribbon constrained method only works with two surfaces); and the present system and methods do not require the surfaces to have the same number of points. The ribbon constrained method requires a 1:1 correspondence of points or vertices between surfaces, whereas no such correspondence is required with systems and methods as described herein.

### Methods

In the various embodiments described herein, the present systems and methods allow one to take a series of surfaces defined by a mesh, or reference grid, and work out the intersection between surfaces and a series of cubic volumes, called voxels, that form the image. In any one or more aspects, the systems and methods allow one to take a series of surfaces defined by an arbitrary mesh or reference grid, having the advantage of avoiding deriving estimates from one grid and leaving the user to then transform those on to another grid and avoiding the associated errors introduced thereby. The surfaces are derived from imaging data of a subject, either provided or that has been provided. From there, the proportion of volumes between a surface or surfaces that intersect with a given cubic volume of a voxel can be determined. The core method within systems and methods described herein estimates the voxel-wise interior/exterior PVs arising from the intersection of a single surface with an arbitrary voxel grid. In various embodiments, systems and methods as described herein assume cuboid voxels with a ‘boxcar’ point-spread function (PSF), which is to say that it does not allow for any mixing of signal between voxels. In reality, different modalities have differing PSFs and such effects may be separately accounted for via a convolution operation.

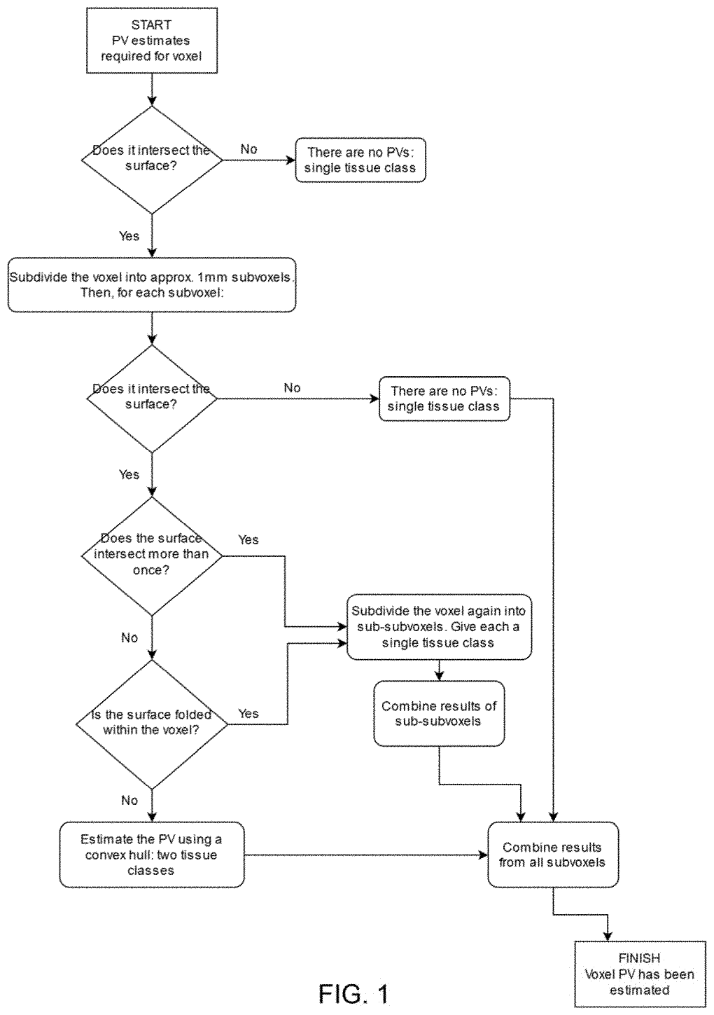

An embodiment described herein is a method for image reconstruction (in an embodiment referred to herein as “Toblerone”). The method can comprise acquiring, providing, or having provided surfaces derived from imaging data from a subject; setting a reference grid, which can be a grid comprised of a plurality of voxels within the imaging data; and mapping the surfaces derived from the imaging data from the subject to the reference grid. Then with reference to FIG. 1, the method begins partial volume (PV) estimation for one or more of the voxels, preferably for each voxel within the reference grid. The PV estimation includes identifying and recording local patches of the surfaces in relation to the voxels and determining if a surface intersects a voxel. In the case where there is no intersection of a surface with a voxel of the reference grid, then regarding that surface there are no partial volumes to estimate and a single tissue class is determined for that surface. In the case the surface intersects a voxel, then: subdividing the voxel by a first subdivision factor into a subvoxel; processing the subvoxel and determining partial volumes by assigning a class volume, wherein assigning a class volume comprises determining if the subvoxel intersects a subject surface, wherein: if it does not intersect subject surface, assigning a single class volume, or if the subvoxel intersects the subject surface, determining whether the surface intersects the voxel more than once. In the case that a surface intersects a voxel once a partial volume estimation is conducted by estimating an interior or exterior partial volume of the surface. In any one or more aspects, the estimation can be carried out with a convex hull and determining the non-convex hull estimated interior or exterior volume by subtracting the convex hull estimated volume from the total subdivided voxel volume. In any one or more aspects, a “convex hull” is defined as the smallest possible region enclosing a set of points within which any two points can be connected without leaving the region. In the case the surface is determined to be folded within the subvoxel or intersects the subvoxel more than once, then subdividing the subvoxel a second time with a second subdivision factor and assigning a single tissue class volume to the subdivided subvoxel. The method continues combining the partial volumes of each individual subvoxel and subdivided subvoxel and reconstructing an image from the combined partial volumes.

A subject as described herein can be any animate or inanimate object to be imaged wherein the imaging involves the imaging of complex structures, in particular complex geometric structures. The methods and systems herein are particularly well adapted to imaging animals. In an embodiment, a subject is a human subject.

The imaging data can be imaging data acquired from lower resolution modalities, examples of which can included functional magnetic resonance data, arterial spin labeling (ASL) data, blood-oxygen level dependent (BOLD) magnetic resonance imaging (MRI) data, or positron emission tomography (PET) data, and other perfusion imaging data. In an embodiment, the imaging data is ASL data. In an embodiment, the data is ASL data acquired from imaging an animal, in particular a human. The imaging data can be acquired as a part of or a step in the method or system. Alternatively, the imaging data can be provided from data previously acquired.

In any one or more aspects, the step of identifying and recording local patches can be carried out using the Separating Axis Theorem. The Separating Axis Theorem (SAT) is a method to determine if two convex shapes are intersecting. Under the theorem, two convex shapes do not overlap if there exists a line (called axis) onto which the two shapes' projections do not overlap. In an embodiment, the identifying and recording is carried out using the Moller's Box-overlap test.

In an embodiment suitable for the human brain, the first subdivision factor is set empirically as ceil (v/0.75) where v is the vector of voxel dimensions and 0.75 represents the lower limit of feature size found in the brain. In other contexts, however, this value can be varied, i.e., set higher or lower depending upon the dimensions of the geometries within the imaging data. In any one or more aspects, the subdivision factor is empirically set such that the dimension of subdivided voxel is less than the surface or is such that the surface intersects the voxel only once. In any one or more aspects, the subdivision factor is set at a value to transform an anisotropic voxel into a substantially isotropic voxel, for example a voxel wherein all the sides of the cubic voxel have substantially the same dimension with uniform resolution in all directions.

In embodiments, a subject surface can represent either the inner or outer boundary of the cerebral cortex, or a subcortical structure. More generally, a subject surface can represent any object, either animate or inanimate, with a sufficiently complex geometry such that partial volume effects are of interest. The surfaces need not represent anatomical structures.

In embodiments, subvoxels are subdivided a second time according to methods as described herein. In embodiments, a second subdivision factor is 5. In other contexts, however, this value can be varied, i.e., set higher or lower depending upon the dimensions of the geometries within the imaging data. In any one or more aspects, the subdivision factor is empirically set such that the dimension of subdivided voxel is less than the surface or is such that the surface intersects the voxel only once.

In certain aspects, methods as described herein comprise providing a subject before providing the imaging data. In embodiments, methods as described herein further comprise positioning the subject in relation to an imaging scanner after providing the subject and acquiring image data, such as image data of the cerebral cortex. In embodiments as described herein, methods as described herein further comprise outputting to an imaging display.

In embodiments, the acquisition of the imaging data can be carried out using a scanner for magnetic resonance imaging (MRI) or positron emission tomography (PET) or other scanners typically used for acquiring medical imaging data.

Methods as described herein further comprise correcting the partial volumes (also referred to herein as partial volume estimations). In an embodiment, correcting is performed using spatialVB (for ASL data). However, other conventional methods for correction of the partial volumes can also be employed.

Also described herein are non-transitory computer readable medium comprising logic that, when executed on a computing device, executes a method as described herein. Such logic could also be packaged into a data packet that can be downloaded from the world wide web.

Also described herein are imaging systems comprising logic that, when executed on a computing device, execute any method as described herein. In embodiments, the systems can include an imaging scanner as described herein.

Also, representative examples are provided herein utilizing the brain (cortex and subcortical structures) of a subject, and functional MRI data (arterial spin-labeling data). The systems and methods described herein can be applied to other anatomical structures in a subject, and to other imaging modalities (in particular other functional imaging modalities with coarse resolution, for example positron emission tomography scanning).

Furthermore, while systems and methods as described herein are optimized for neuroimaging in human subjects, where the size of features of interest is in on the scale of about 1 mm, such systems and methods can be tuned and optimized for other structures that may have a larger or smaller size (for example with structures of interest on the nanometer scale). While 1 mm and subdivisions to ˜0.1 mm or ˜0.2 mm voxels and subvoxels (for example by subdividing according to a factor of 5) are described herein, it would be understood that these numerical values and subdivisions can be varied according to the structure[s] of interest to be imaged.

### Systems

Described herein are systems for acquiring and reconstructing images, in particular MR images that can image structures otherwise invisible to the naked eye. Such systems can be functional imaging systems that detect dynamic changes in a subject, for example functional MRI or PET. The subject can be, but need not be, a human patient. The subject can also be an animal, plant or inanimate subject. The subject can have a vascular system of interest. In various aspects, the methods and systems herein can comprise an MR scanner with a plurality of transmit channels and an image reconstruction computer (computers and processors described more in depth later in the discussion). They can also comprise a measurement and physiological control unit (MPCU), analog-to-digital converters (ADCs), a specific absorption rate (SAR) monitoring system, and a plurality of RF transmit, receive, or transmit/receive coils that can be positioned near or around a region of interest (ROI) of a subject.

### Computing Devices

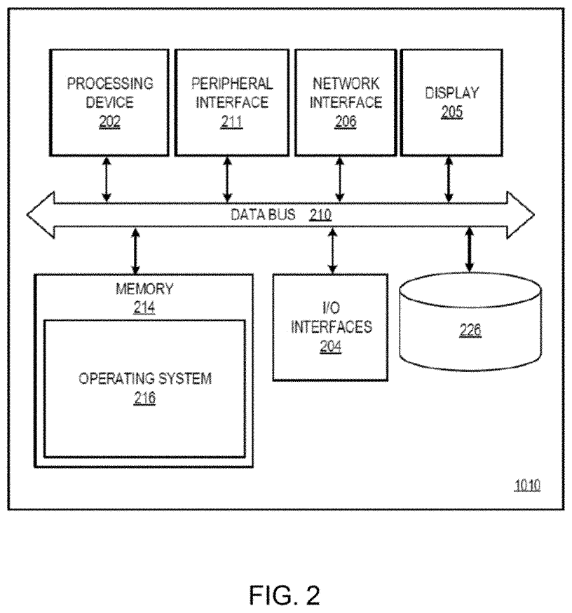

FIG. 2 depicts an apparatus 1010 in which the systems, analysis systems, analysis systems, or other systems described herein may be coupled to in order to assist in automation of the system. The apparatus 1010 can be embodied in any one of a wide variety of wired and/or wireless computing devices, multiprocessor computing device, and so forth. As shown in FIG. 2, the apparatus 1010 comprises memory 214, a processing device 202, a number of input/output interfaces 204, a network interface 206, a display 205, a peripheral interface 211, and mass storage 226, wherein each of these devices are connected across a local data bus 210. The apparatus 1010 can be coupled to one or more peripheral measurement devices (not shown) connected to the apparatus 1010 via the peripheral interface 211.

The processing device 202 can include any custom made or commercially available processor, a central processing unit (CPU) or an auxiliary processor among several processors associated with the apparatus 1010, a semiconductor based microprocessor (in the form of a microchip), a macroprocessor, one or more application specific integrated circuits (ASICs), a plurality of suitably configured digital logic gates, and other well-known electrical configurations comprising discrete elements both individually and in various combinations to coordinate the overall operation of the computing system.

The memory 214 can include any one of a combination of volatile memory elements (e.g., random-access memory (RAM, such as DRAM, and SRAM, etc.)) and nonvolatile memory elements (e.g., ROM, hard drive, tape, CDROM, etc.). The memory 214 typically comprises a native operating system 216, one or more native applications, emulation systems, or emulated applications for any of a variety of operating systems and/or emulated hardware platforms, emulated operating systems, etc. For example, the applications can include application specific software which may be configured to perform some or all of the methods described herein (Labview, for example). In accordance with such embodiments, the application specific software is stored in memory 214 and executed by the processing device 202. One of ordinary skill in the art will appreciate that the memory 214 can, and typically will, comprise other components which have been omitted for purposes of brevity.

Input/output interfaces 204 provide any number of interfaces for the input and output of data. For example, where the apparatus 1010 comprises a personal computer, these components may interface with one or more user input devices 204. The display 205 can comprise a computer monitor, a plasma screen for a PC, a liquid crystal display (LCD) on a hand held device, or other display device.

In the context of this disclosure, a non-transitory computer-readable medium can store programs for use by or in connection with an instruction execution system, apparatus, or device. More specific examples of a computer-readable medium can include by way of example and without limitation: a portable computer diskette, a random access memory (RAM), a read-only memory (ROM), an erasable programmable read-only memory (EPROM, EEPROM, or Flash memory), and a portable compact disc read-only memory (CDROM) (optical). Such medium can also comprise or otherwise store logic that, when executed, performs methods as described herein.

With further reference to FIG. 2, network interface device 206 comprises various components used to transmit and/or receive data over a network environment. For example, the network interface 206 can include a device that can communicate with both inputs and outputs, for instance, a modulator/demodulator (e.g., a modem), wireless (e.g., radio frequency (RF)) transceiver, a telephonic interface, a bridge, a router, network card, etc.). The apparatus 1010 can communicate with one or more computing devices via the network interface 206 over a network. The apparatus 1010 may further comprise mass storage 226. The peripheral 211 interface supports various interfaces including, but not limited to IEEE-1394 High Performance Serial Bus (Firewire), USB, thunderbolt, a serial connection, and a parallel connection.

The apparatus 1010 shown in FIG. 2 can be embodied, for example, as a magnetic resonance apparatus, which includes a processing module or logic for performing conditional data processing and may be implemented either off-line or directly in a magnetic resonance apparatus. For such embodiments, the apparatus 1010 can be implemented as a multi-channel, multi-coil system with advanced parallel image processing capabilities, and direct implementation makes it possible to generate images, for example, immediate T1 maps, available for viewing immediately after image acquisition, thereby allowing re-acquisition on-the-spot if necessary. Examples of apparatus in which the present systems and methods may be implemented are described in U.S. Pat. Nos. 5,993,398 and 6,245,027 and U.S. Publication No. 2011/0181285, which are incorporated by reference as if fully set forth herein.

The flow chart of FIG. 1 shows an example of functionality that can be implemented in the apparatus 1010 of FIG. 2. If embodied in software, each block shown in FIG. 1 can represent a module, segment, or portion of code that comprises program instructions to implement the specified logical function(s). The program instructions may be embodied in the form of source code that comprises machine code that comprises numerical instructions recognizable by a suitable execution system such as the processing device 202 (FIG. 2) in a computer system or other system. The machine code can be converted from the source code, etc. If embodied in hardware, each block may represent a circuit or a number of interconnected circuits to implement the specified logical function(s).

Although the flowchart of FIG. 1 shows a specific order of execution, it is understood that the order of execution may differ from that which is depicted. For example, the order of execution of two or more blocks may be scrambled relative to the order shown. Also, two or more blocks shown in succession in FIG. 1 can be executed concurrently or with partial concurrence. Further, in some embodiments, one or more of the blocks shown in FIG. 1 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

### Computer-Readable Media

Also, any logic or application described herein that comprises software or code can be embodied in any non-transitory computer-readable medium for use by or in connection with an instruction execution system such as, for example, a processing device 202 in a computer system or other system. In this sense, each may comprise, for example, statements including instructions and declarations that can be fetched from the computer-readable medium and executed by the instruction execution system.

Imaging systems as described herein can further comprise a display to which images can be outputted for display by a user. In certain embodiments, methods as described herein can be implemented on the scanner's image reconstruction system. The image reconstruction system can further comprise a display upon which reconstructed images are outputted to. In certain embodiments, systems and methods as described herein can comprise a Magnetom 7T (Siemens, Erlangen Germany) equipped with an 8 channel PTx and local SAR monitor (VB17 step 2.3).

### EXAMPLES

Now having described various embodiments of the disclosure, in general, the examples below describe some additional embodiments. While embodiments of the present disclosure are described in connection with the examples and the corresponding text and figures, there is no intent to limit embodiments of the disclosure to these descriptions. On the contrary, the intent is to cover all alternatives, modifications, and equivalents included within the spirit and scope of embodiments of the present disclosure.

### Example 1

Provided herein is a new method, called Toblerone, for estimating PVs for complex structures, such as the cerebral cortex and subcortex. In this example, it uses a geometric approach that considers the intersection between a surface and the voxels of an image. In contrast to existing surface-based techniques, Toblerone is not restricted to use with any particular structure or modality.

Evaluation in a neuroimaging context has been performed on simulated surfaces, simulated T1-weighted MRI images and finally a Human Connectome Project test-retest dataset. A comparison has been made to two existing surface-based methods; in all analyses Toblerone's performance either matched or surpassed the comparator methods. Evaluation results also show that compared to an existing volumetric method (FSL FAST), a surface-based approach with Toblerone offers improved robustness to scanner noise and field non-uniformity, and better inter-session repeatability in brain volume. In contrast to volumetric methods, a surface-based approach as described herein negates the need to perform resampling which is advantageous at the resolutions typically used for neuroimaging.

### I. Introduction

Partial volume effects (PVE) arise when an imaging matrix has low spatial resolution in relation to the structures of interest within the image, as is commonly the case for functional imaging techniques such as positron emission tomography (PET), blood oxygen-level dependent fMRI (BOLD) and arterial spin labelling (ASL). For example, ASL voxels typically have side lengths of 3-4 mm whereas the mean thickness of the adult cortex is 2.5 mm [1]. As such, voxels around the cortex will contain a mixture of cortical and noncortical tissues, the proportions of which are termed partial volumes (PVs). PVE present a source of confound for functional imaging: whilst the objective is to obtain a measurement of function across some particular structure, the signal actually measured in each voxel is a sum, weighted by the partial volumes, of function both within and without said structure. This is a mixed-source problem in which the multiple tissues in each voxel constitute the sources. Partial volume effect correction (PVEc) uses voxel-wise estimates of PVs to separate out the signal arising from each tissue. Various PVEc methods have been developed, usually with a specific modality in mind (for example, Muller-Gartner for PET [2] and linear regression [3] or spatially-regularized variational Bayes for ASL [4]).

Estimation of PVs bears considerable similarity to volumetric segmentation and the two are typically performed concurrently on a structural image, as is demonstrated in [5]. In order to obtain PV estimates within the voxel grid of a functional image, estimates in the grid of a structural image must further be transformed. As each functional voxel corresponds to multiple smaller voxels on the structural image, the PVs of the former can be determined from the estimates of the latter. The efficacy of this approach is limited by the accuracy of the volumetric segmentation approach used. For complex geometries, such as the thin and highly folded structure of the cerebral cortex, the alternative of surface-based segmentation has gained widespread support (notably through FreeSurfer [6]). The advantage of such a segmentation method is twofold. Firstly, whereas volumetric segmentation is necessarily a discrete operation in terms of voxels, a surface approach is somewhat continuous as the surface vertices are placed with subvoxel precision. Secondly, anatomically informed constraints can be enforced anisotropically when surfaces are used: for example, the constraint that tissues should be homogenous along a surface but heterogeneous across it. This is in contrast to a volumetric tool such as FSL FAST [7] which does enforce a similar tissue continuity constraint via the use of Markov random fields but only isotropically in the neighborhood of each voxel. In principle, it should be possible to estimate PVs by considering the geometry of intersection between the individual voxels of an image and the surface segmentations of individual structures. Being a geometric construct, namely, given a surface that intersects a voxel, what is the volume within the voxel bounded by the surface? This is a fundamentally different approach to existing methods and it is reflected in the estimates produced.

Although surface-based PV estimation tools exist in the literature, past efforts have usually been designed with a specific modality in mind. Two notable examples for neuroimaging are the ribbon-constrained (RC) method used within the Human Connectome Project's (HCP) fMRISurface pipeline [8] and PETSurfer [9], [10], a variant of FreeSurfer. The former is designed for use with BOLD and so distinguishes only between cortex and otherwise, not the grey matter (GM), white matter (WM) and non-brain required for ASL and PET; whereas the latter is both PET-specific and tightly integrated into FreeSurfer such that it is hard to use independently of that workflow. Furthermore, both methods deal exclusively with surfaces representing the cortex. The objective of this work was to develop a method, named Toblerone1, to estimate partial volumes for both cortical and subcortical structures (where such surfaces are available, for example via FSL FIRST [11]) for neuroimaging applications. Although validated in MRI data, the end result is highly general and could be used with images from multiple modalities and/or in other parts of the body.

### II. Theory

Voxelisation is the process of quantifying the volume contained within a surface and many algorithmic implementations are given in the computer graphics literature. The key step within this operation is determining if a point lies interior or exterior to a given surface; by repeating this test entire volumes can be built up. The ray intersection test outlined by Nooruddin and Turk [12] is widely used for this and requires only that the surfaces be contiguous (water-tight). The test is performed by projecting an infinite ray in any direction from the point under test and counting the number of intersections made with the surface. A ray from an interior point will make an odd number of intersections as it exits the surface (including folds within the surface, there will be one more point of exit than entry); conversely an exterior point will make an even number of intersections (balanced entries and exits), if at all. This test scales badly with increasing spatial resolution: for a linear resolution of n samples per unit distance, n″ tests per unit volume are required. Furthermore, as each ray must be tested against each surface element, the test also scales with surface complexity (linearly for a naïve implementation). For a typical functional image of 10% voxels and 2.5×10% surface elements in a FreeSurfer cortical surface, this is prohibitively computationally intensive.

The method adopted in the present disclosure is to only use the portion of surface that actually intersects a given voxel (termed the ‘local patch’) for ray intersection testing. The local patch is defined as all triangles that intersect the voxel or, equivalently, the minimal set of triangles that unambiguously divides the voxel into two regions. This patch is by definition non-contiguous, so it is necessary to modify the ray intersection test accordingly; the modified form is referred to as the ‘reduced’ test in contrast to the ‘classical’ test. Within each voxel, a ‘root point’ that is known to lie within the surface is identified via the classical ray test. Any other point within the voxel may then be tested by projecting the finite line segment:

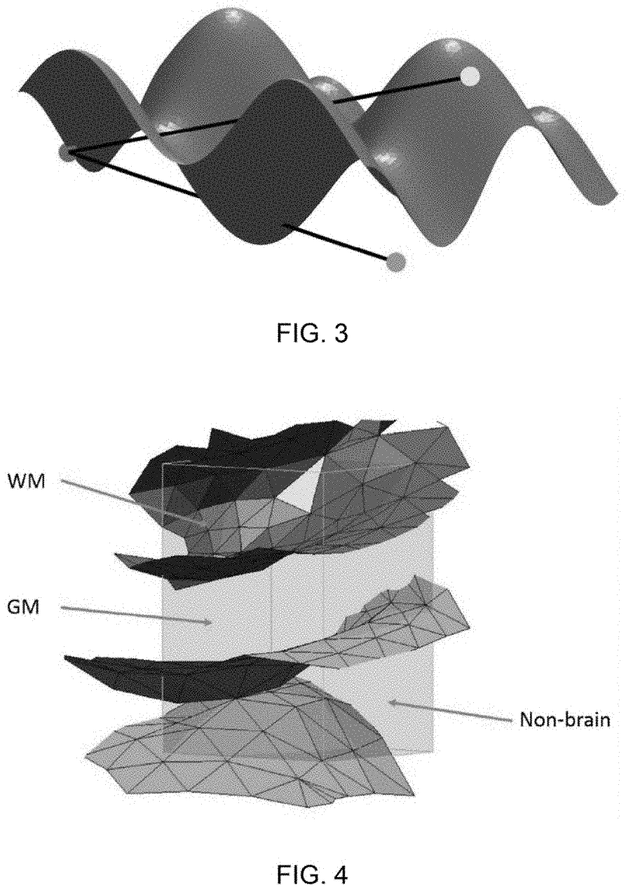

r=pt+λ(pr−pt) (eq.1)
where pt is the point under test, pr is the root point and 0≤λ≤1 is a distance multiplier along the line. A parity test is then applied to the number of intersections identified between the root and test points. The fact that the line terminates at a point interior to the surface means that exterior points will lead to one more point of entry than exit; conversely interior points will lead to either zero or an even number of intersections. It is not necessary to test surface elements outside the voxel as the finite length of the line segment means it can never leave the voxel. FIG. 3 provides an illustration of the test in practice.

In order to minimize the number of tests required per voxel, convex hulls (defined as the smallest possible region enclosing a set of points within which any two points can be connected without leaving the region) are used to estimate partial volumes wherever possible. The rationale for this is that if the extrema points of a region can be classified as interior/exterior to a surface then, to an approximation, all points lying within the convex hull of these points will share the same classification.

### III. Method

The following section provides an example PV estimation for structures within the brain, for which the tissue classes of interest are GM, WM and non-brain of the present disclosure. The same principles can apply to structures in other areas of the body, though the interpretation of tissue classes would differ.

A. Estimation for a Single Surface

The core method within Toblerone estimates the voxel-wise interior/exterior PVs arising from the intersection of a single surface with an arbitrary voxel grid. Toblerone assumes cuboid voxels with a ‘boxcar’ point-spread function (PSF), which is to say that it does not allow for any mixing of signal between voxels. In reality, different modalities have differing PSFs and such effects may be separately accounted for via a convolution operation.

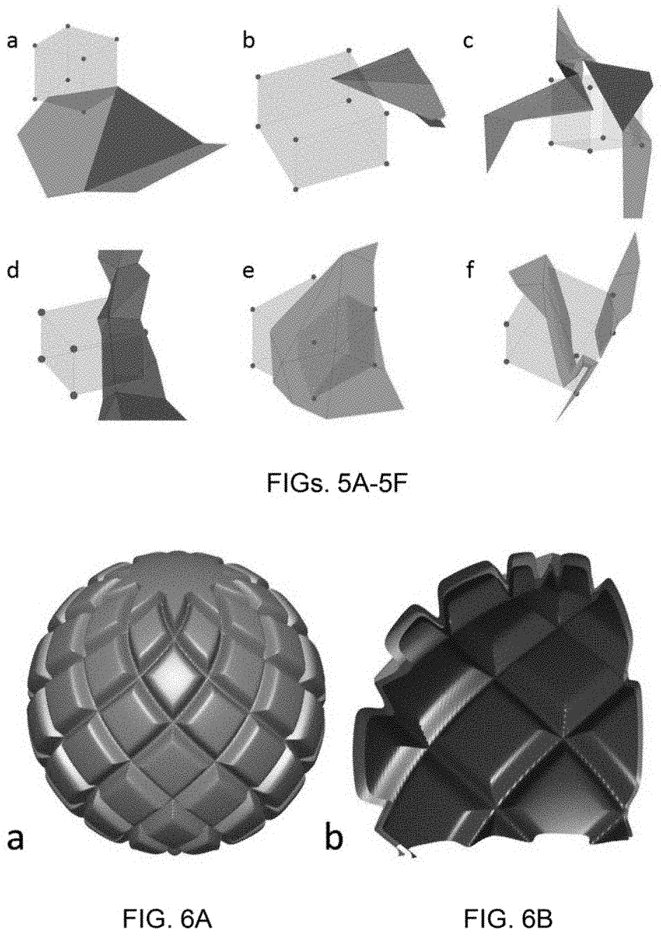

The first step is to identify and record the local patches of surface intersecting each voxel of the reference grid via Moller's triangle-box overlap test [13]. The geometry of a surface within a voxel can frequently be complex: using a sulcus of the cortex as an example, the surface may intersect the voxel multiple times, with the opposite banks of the sulcus appearing as two unconnected patches of surface, illustrated in FIG. 4 (depicting white matter (WM), gray matter (GM) and non-brain matter). Accounting for the many possible surface/voxel configurations requires numerous specific tests that rapidly become excessively complex, so the approach taken in Toblerone is to divide and conquer each voxel as required. As the length scale of a voxel decreases, the complexity of the local surface configuration within the voxel will also decrease (for example, a sulcus is less likely to intersect the voxel multiple times). Each voxel of the reference image is therefore divided into a number of subvoxels which are processed individually. The subdivision factor has been set empirically as ceil (v/0.75) where v is the vector of voxel dimensions and 0.75 represents the lower limit of feature size found in the brain (in other contexts this parameter could be varied). Note that this subdivision factor transforms anisotropic voxels into approximately isotropic subvoxels. This subdivision factor can be adjusted up or down depending upon the type and complexity of the structure to be imaged. Subvoxels are then processed according to the following framework.
If the subvoxel does not intersect the surface, it is assigned a single-class volume according to an interior/exterior classification of its centre. This is illustrated in FIG. 5A.
If the subvoxel intersects the surface, then it contains interior and exterior PVs. One of these will be estimated using a convex hull (via the Qhull implementation [14]) if the geometry of the surface is favourable, as follows:
   If the surface intersects entirely through one face of the subvoxel, then it encloses a highly convex volume that may be reliably estimated. The other partial volume is calculated by subtraction from the total subvoxel volume. This is illustrated in FIG. 5B.
   If the surface is folded within the subvoxel (identified by multiple intersection of the surface along an edge or face diagonal of the subvoxel) then the subvoxel is subdivided a second time. This is because it is difficult to reliably identify which volume is interior or exterior in such a situation. This is illustrated in FIGS. 5C-5D.
   In all other cases, convex hulls are again used. In order to minimize the potential error associated with estimation of a non-convex volume via the use of a convex hull, it is important to identify which of the two PVs within the subvoxel is closer to being genuinely convex than the other. The proxy measure used for this is the number of subvoxel vertices lying on either side of the surface: the side with fewer vertices is assumed to enclose a more convex (and at any rate smaller) volume than the other. This is illustrated in FIG. 5E.
If the surface intersects the subvoxel multiple times (identified by the successful separation of surface nodes lying within the subvoxel into unconnected groups) then the voxel is subdivided a second time. This situation occurs for example when the opposite banks of a sulcus pass through a voxel. Although the reduced ray intersection test is accurate in such a situation, forming convex hulls is not, so subdivision is the safer option. This is illustrated in FIG. 5F.

If required, the second subdivision is performed at a constant factor of 5 to yield sub-subvoxels of approximately 0.1 to 0.2 mm side length isotropic. This constant factor can also be adjusted up or down depending upon the structure to be imaged. These are always assigned a single-class volume based on a classification of their centre points as their small size means that any PVE will be negligible. Finally, voxels that do not intersect the surface (fully interior or exterior) are given single-class volumes according to tests of their centre points. Structures defined by a single surface (e.g., the thalamus) require no further processing: the estimates produced by the aforementioned steps may be used directly for PVEc.

B. Multiple-Surface Structures

Structures that are defined by multiple surfaces require further processing to yield PV estimates for all tissues of interest. Using the cortex as an example, PVs within each hemisphere are obtained with the relations:

PV_{WM}=Pᵢₙₙₑᵣ (eq. 2)

PV_{GM}=(0,Pₒᵤₜₑᵣ−Pᵢₙₙₑᵣ) (eq. 3)

PV_{NB}=1−(PV_{WM}+PV_{GM}) (eq. 4)

Where Pᵢₙₙₑᵣ and Pₒᵤₜₑᵣ denote the interior/exterior PV fractions associated with the inner and outer surfaces of the cortex respectively and PV_{WM}, PV_{GM} and PV_{NB} denote the PV estimates for WM, GM and non-brain tissue (the latter including cerebrospinal fluid, CSF). These equations are structured to account for a potential surface defect whereby the surfaces of the cortex swap relative position (the inner lying exterior to the outer) around the corpus collosum. The structure of the above relations N surfaces leading to N+1 tissue classes) can easily be generalized to structures defined by more than two surfaces (for example, sublayers of the cortex, as used in laminar fMRI). A similar set of equations can be used to merge hemisphere-specific results to cover the whole cortex, accounting for voxels lying on the mid-sagittal plane that intersect both hemispheres.

C. Whole-Brain PV Estimation

Toblerone, as outlined above, operates on a structure-by-structure basis in which the output tissue types are dependent on the structure in question. A number of methods utilizing this core functionality were implemented:
1) estimate_structure: estimate the inner and outer PVs associated with a structure defined by a single surface
2) estimate_cortex: estimate the GM, WM and non-brain PVs associated with the four surfaces of the cortex (I/r white/pial in the FreeSurfer terminology)
3) estimate_all: a combination of the structure and cortex methods above, this estimates PVs for the cortex and all subcortical structures identified by FIRST and combines them (with the exception of the brain stem) into a single set of GM, WM and non-brain PV estimates. The run-time for a typical subject was around 25 minutes.

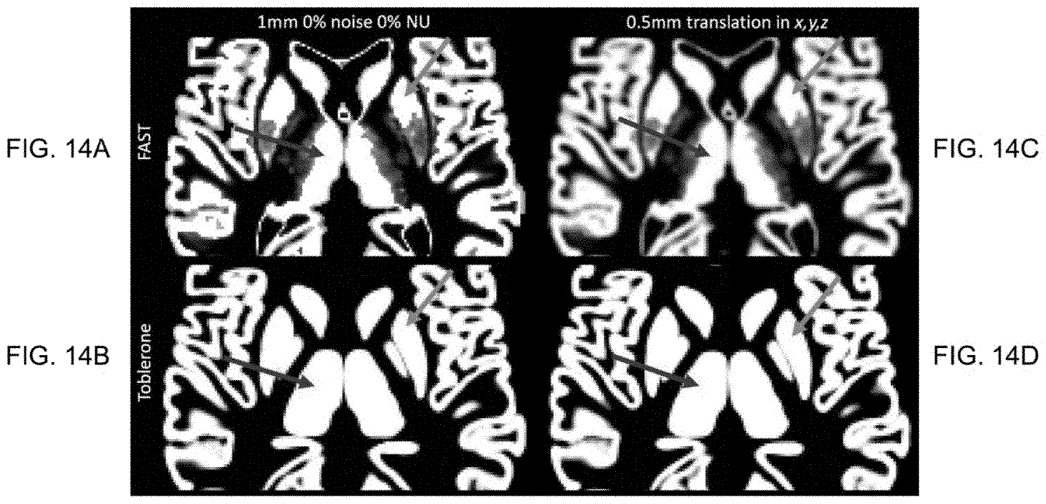

The combination of FreeSurfer/FIRST and estimate_all provides a complete pipeline for obtaining whole-brain PV estimates in an arbitrary reference voxel grid from a single T1-weighted image that may be used as a replacement for existing volumetric tools such as FAST. There can be, however, a key conceptual difference between surface and volumetric methods that concerns their interpretation of subcortical structures. Due to differences in tissue composition around the brain, cortical and subcortical GM have different intensities on a normal T1-weighted image and are accordingly assigned different GM PVs by volumetric tools such as FAST (whereby cortical GM is seen as more ‘grey’ than subcortical, as illustrated in FIGS. 14A-14D). Surface-based methods, by contrast, do not take a view on what tissue lies within a surface other than simply asserting that it is different to that which lies without. When combining the PVs of individual structures in Toblerone's estimate_all function, all tissue within the cortex and subcortical structures is interpreted as pure GM. The practical implication of this is that Toblerone's estimates for subcortical GM are higher than those produced by FAST. For this reason, the conventional GM/WM/CSF tissue classes used by volumetric tools may be better thought of within Toblerone's framework as tissue of interest, other tissues and non-brain, though for the purposes of the present disclosure the familiar names GM and WM shall be used alongside non-brain. The inherent ambiguity in determining which tissues lie outside subcortical structures, which could be either WM or CSF depending on their location within the brain, was resolved using FAST's segmentation results. Note: as it is ambiguous as to what tissue lies outside a given subcortical structure given only its surface, FAST's results for the same voxel are used as an estimate for the local ratio of WM and CSF. The actual quantity of non-GM tissue can be calculated from the surface estimate as the remainder 1−GM, which is then shared between the other two classes in this ratio.

### IV. Evaluation

Three datasets and three comparator methods were used, as summarized in Table I. The two surface-based comparator methods were restricted to use in the cortex only. Toblerone was run on both cortical and subcortical surfaces where appropriate to produce whole-brain PV estimates.

TABLE I
DATASETS & METHODS USED

| | Simulated | | |
|---|---|---|---|
| name | surfaces | Brain Web | HCP test-retest |
| type | S | V + S | V + S |
| resolution | — | 1 mm iso. | 0.7 mm iso. |
| size | 1 cortical | 18 simulated | 45 subjects, |
| | hemisphere | T1 images | 2 sessions each |
| ground truth | numerical | volumetric | N/A |
| | method | segmentation* | |
| comparator | NeuroPVE (S) | RC** (S) | RC** (S) |
| methods | RC (S) | FAST (V) | FAST (V) |

S surface, V volumetric, RC ribbon-constructed method
*established via automatic segmentation with manual intervention
**RC can only be run on the cortex for these datasets

A. Comparator Methods

The first surface-based comparator method, the ribbon-constrained (RC) algorithm, was developed for use with BOLD data in the HCP's fMRISurface pipeline [8] and is restricted to use in the cortex only. The method assumes vertex correspondence between the two surfaces of the cortex and works as follows. For each vertex in turn, the outermost edges of the triangles that surround said vertex are connected between the two surfaces to form a 3D polyhedron representing a small region of cortex. Nearby voxels are subdivided and the centres of the subvoxels tested to determine if they lie interior to the polyhedron. The subdivision factor used in this work was the higher value of either ceil(max(v)/0.4) or 4, where v is the vector of voxel dimensions. The fraction of subvoxel centres lying within any cortical polyhedron gives the cortical GM PV, which, as the BOLD signal is predominantly cortical in origin, is the quantity of interest for this modality.

In order to obtain WM and non-brain PVs, the following post-processing steps were used. Firstly, the unassigned PV of each voxel was calculated as 1−PV_{GM}, which was subsequently labelled as either WM or non-brain according to a signed-distance test of the voxel centre in comparison to the cortical mid-surface: for a voxel with centre point outside the mid-surface, the unassigned PV was labelled as non-brain. A weakness of this approach is that it is unable to faithfully capture a voxel in which all three tissues are present; only the combinations WM/GM or GM/non-brain are permitted. As voxel size increases, the probability of voxels containing multiple tissues also increases; testing on an image of 3 mm isotropic resolution showed that around 30% of voxels intersecting the cortical ribbon contained three tissues. Resampling can be used to mitigate this effect so two variants of this method were tested: ‘RC’, direct estimation at each resolution, and ‘RC2’, estimation at 1 mm followed by resampling to other resolutions via the process in section IV.B. The run-time for a typical subject was around 15 minutes.

This second surface method, NeuroPVE [15], uses a voxelisation method based on the work of [9,12], applied in a brain-specific context and again restricted to use in the cortex only. Multiple expanded and contracted copies of each surface are created and the ratio of expanded to contracted surfaces intersecting a given voxel is used as a first approximation for partial volumes. This ratio is then mapped, along with surface orientation information, via trigonometric relations on the unit cube into a PV estimate. The estimates produced take discrete values according to the number of surfaces used (in this work the default of 5). The intended use of this tool was PV estimation at structural, not functional, resolution, so two variants were tested: ‘Neuro’, direct estimation at arbitrary resolutions, and ‘Neuro2’, estimation at structural resolution followed by resampling to other resolutions via the process in section IV.B. On the basis of NeuroPVE's results on the simulated surfaces, it was excluded from further analysis. As the process of surface inflation is slow, the run-time for a typical subject was around 12 hours.

Finally, FSL's FAST [7] is an established whole-brain volumetric segmentation tool that was used as a comparator for the surface methods. On both the BrainWeb and HCP test-retest datasets, FAST was run on the brain-extracted images at structural resolution (1 mm and 0.7 mm iso. respectively). PVs were then obtained at other resolutions via the resampling method detailed in section IV.B. The run-time for a typical subject was around 5 minutes.

B. Resampling

Resampling is an interpolation operation that is used to transform volumetric data between voxel grids (in this context, from structural to functional resolution). FSL's applywarp tool was used with the -super flag for all resampling operations. This works by creating an up-sampled copy of the target voxel grid onto which values from the input image are sampled. The average is then taken across the voxel neighborhoods of the high-resolution grid (sized according to the up-sampling factor) to obtain the result in the target voxel grid. Such an approach is appropriate when moving from fine to coarse as each output voxel corresponds to multiple input voxels, the individual contributions of which should be accounted for to preserve overall tissue proportions. When using applywarp a transformation matrix between the input and output voxel grids must be given as the -premat argument; to denote identity for the purposes of this work, the output of the HCP wb_command -convert-affine -from-world -to-flirt tool operating on I4 was used as the -premat to correct for a subvoxel shift that arises due to FSL coordinate system conventions. Note that for perfectly aligned voxel grids with an integer ratio of voxel sizes, such as a 1 mm and 2 mm isotropic grid, this process is equivalent to averaging across blocks of the smaller grid (sized 2×2×2 in this case).

C. Simulated Surfaces

A pair of concentric surfaces illustrated in FIGS. 6A-6B, were designed to capture geometric features relevant to the anatomy of a cortical hemisphere. These were produced by modulating the radius of a sphere as a function of azimuth θ and elevation ϕ to produce sulci and gyri-like features. The radius of the inner surface was defined as

rᵢₙ=60(1−0.1 max(sin²⁰5u,sin²⁰5v) (eq. 5)

where 60 is the unmodulated radius of the sphere, 0.1 fixes the relative depth of sulci, the max function prevents sulci from constructively interfering to produce deep wells at points of intersection, the power of 20 produces broad gyri and narrow sulci, and the substitutions u=ϕ+θ, v=ϕ−θ cause the sulci to spiral around the sphere in opposite directions. Modulation was restricted to the range −2π/5≤θ≤2π/5 to leave the poles smooth and suppress unrealistic features. The outer radius was set at rₒᵤₜ=1.05·rᵢₙ, leading to a peak radial distance between surfaces of 3 mm. The outermost region was taken to represent non-brain tissue, the innermost WM and the region in between GM. The use of analytic functions to define the surfaces permitted ground truth to be calculated using the following numerical method. Voxels were sampled at 4,096 elements per mm3 and the positions of these sample points expressed in spherical polar coordinates. By comparing the actual radius of each point to the calculated radius of the surface boundaries for the same azimuth and elevation, the tissue type of the sample point within the structure could be determined, and from there PVs obtained by aggregating results within voxels. This is referred to as the ‘numerical solution’ in the results section. All surface methods were used on this dataset to obtain PVs at voxel sizes of 1 to 3 mm in steps of 0.2 mm isotropic.

D. BrainWeb Simulated T1 Images

BrainWeb [16], [17] simulates whole-head T1 images at 1 mm isotropic resolution with specified levels of random noise and field non-uniformity (NU). Eighteen images were produced to cover the available parameter space of noise levels {0, 1, 3, 5, 7, 9} and NU levels {0, 20, 40} (both quantities in percent). These were run through FIRST and FreeSurfer, after which Toblerone's estimate_all and the RC method (cortex only) were used on the output. FAST was also used to enable a comparison between surface and volumetric methods. PVs were obtained at voxel sizes of 1 to 4 mm in steps of 1 mm isotropic. Although ground truth PV maps exist for this dataset (produced by automatic volumetric segmentation of T1 images with manual correction [16]), both surface and volumetric methods returned significantly different results to these, raising the complicated question of determining which set of results is correct. In order to avoid making this judgement, each method was instead referenced to its own results on the ideal T1 image (0% noise 0% NU) in the 1 mm isotropic voxel grid of the structural images. The voxel grids associated with each voxel size were aligned such that results at 1 mm could be used to calculate a reference at other sizes.

E. Human Connectome Project Test-Retest Data

This dataset comprises 45 subjects from the main HCP cohort who underwent two separate structural scan sessions (mean age 30.2 years, mean time between sessions 4.8 months). Each session was processed using the pipeline in [8] to obtain cortical surfaces via FreeSurfer. Separately, the distortion-corrected T1 images were processed using FIRST to obtain subcortical surfaces. Toblerone's estimate_all and the RC method (for the cortex only) were used on this dataset, as well as FAST for a comparison between surface and volumetric methods. PVs were obtained at voxel sizes of 1 to 3.8 mm in steps of 0.4 mm isotropic, as well as the native 0.7 mm isotropic voxel grid of the structural images. Although a ground truth is not defined for this dataset, each method's results from the first session were used as a reference for the second session.

F. Evaluation Metrics

Errors were measured in both a per-voxel (root-mean-square, RMS, of individual voxel errors) and aggregate (total tissue volume) sense. The former basis is important as PVEc is locally sensitive to the PV estimates [18]; the latter basis reflects systematic bias at the aggregate level. All errors are expressed in percent and map directly to PV estimates without scaling: for example, a PV estimate of 0.5 against a reference value of 0.55 corresponds to an error of −0.05 or −5%.

A further analysis of voxel-wise differences between Toblerone and FAST was performed on the HCP dataset at multiple voxel sizes by sorting voxels into 5% width bins according to their Toblerone GM PV estimate. The difference (Toblerone−FAST) was calculated for each voxel and the mean taken across each bin. This quantity was then averaged across subjects and sessions (weighted to respect differences in brain volume).

### V. Results

A. Simulated Surfaces

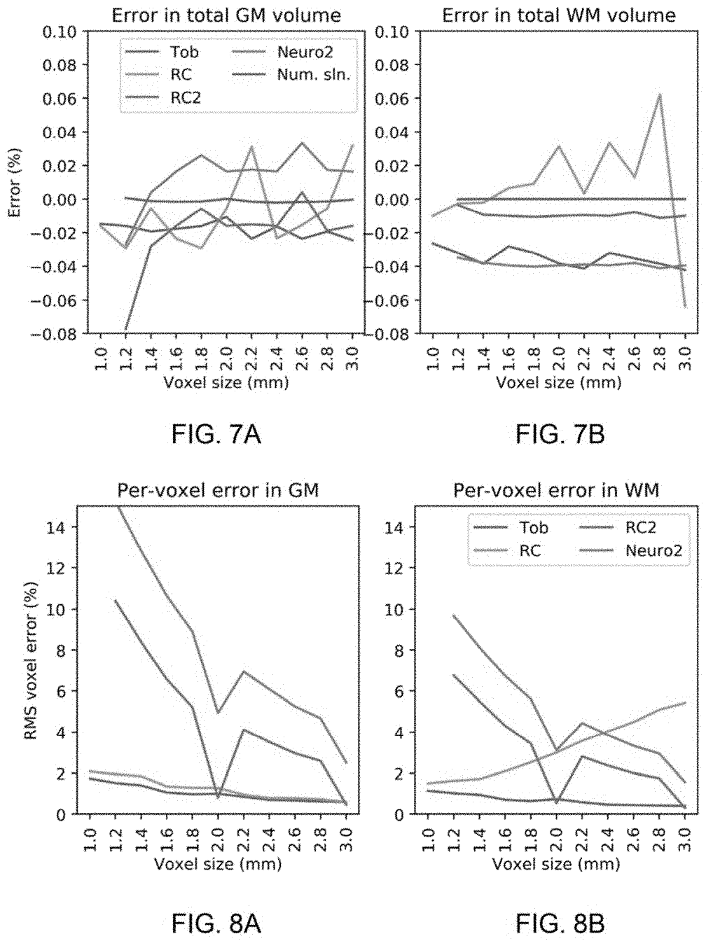

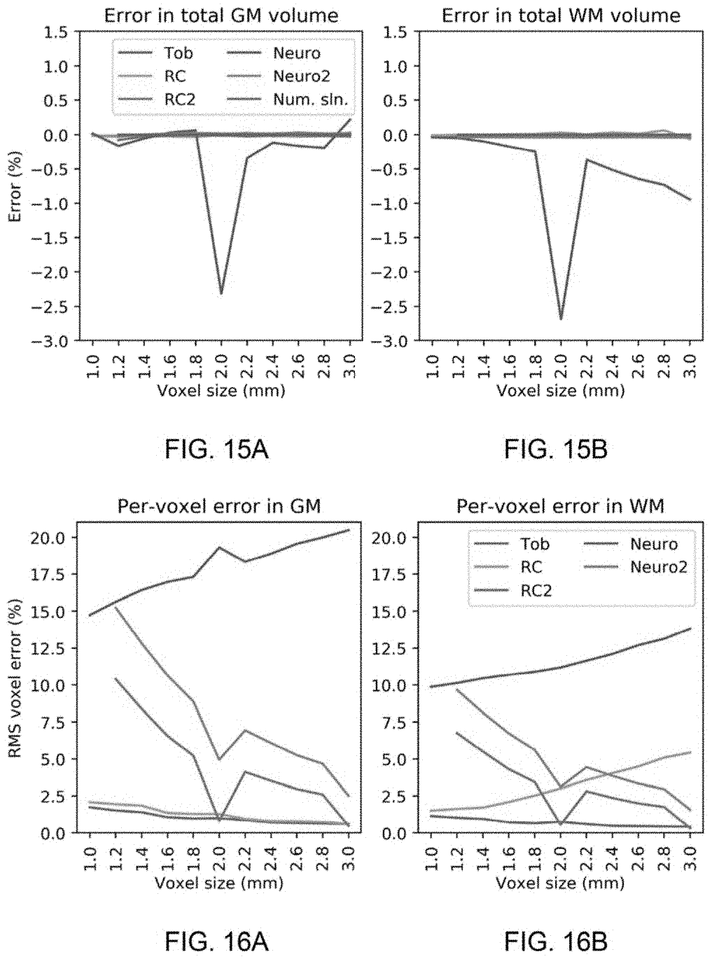

FIGS. 7A-7B show the error in total tissue volume for the simulated surfaces. The numerical solution at 1 mm was used as the reference. Toblerone showed consistency across voxel sizes, though with a small negative bias in both GM and WM. RC estimates showed variation in both. The resampling-based methods RC2 and Neuro2 showed high consistency in WM but less so in GM. The numerical solution was stable across voxel sizes. Neuro's results are excluded from this and subsequent graphs for clarity; the full results are given in the supplementary material (FIGS. 15A-15B and FIGS. 16A-16B).

FIGS. 8A-8B show per-voxel error for the simulated surfaces. Results were masked to consider voxels intersecting either surface of the cortex as only these contain PVs. Toblerone and RC produced the lowest errors at all voxel sizes in GM; in WM only Toblerone retained this behavior. Resampling-based methods (RC2, Neuro2) produced lower errors as voxel size increased, and a characteristic notch in their results was observed at 2 mm. Although RC initially performed better than RC2 in WM, the inverse was true above 2 mm voxel size.

B. BrainWeb Simulated T1 Images

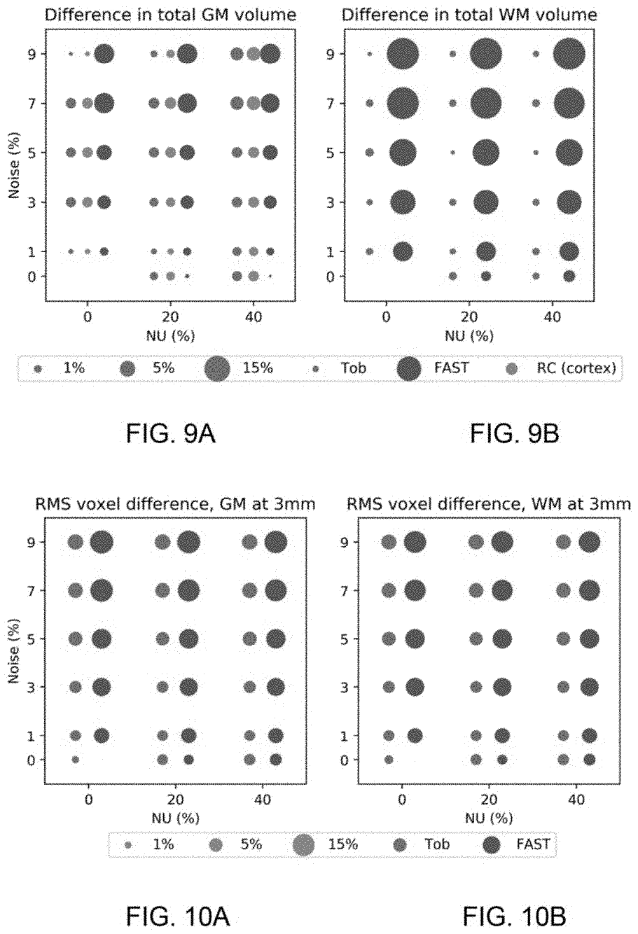

FIGS. 9A-9B show the difference in total tissue volume across the brain as a function of noise and NU levels, referenced to each method's results at 0% noise and 0% NU. PV estimates at 1 mm isotropic voxel size were used for this analysis. RC's GM result was for the cortex only as it cannot process subcortical structures. In general, the surface-based methods showed more consistency in their estimates across all levels of noise and NU, with the notable exception of GM at 0% noise. FAST's consistency was notably better in GM than WM.

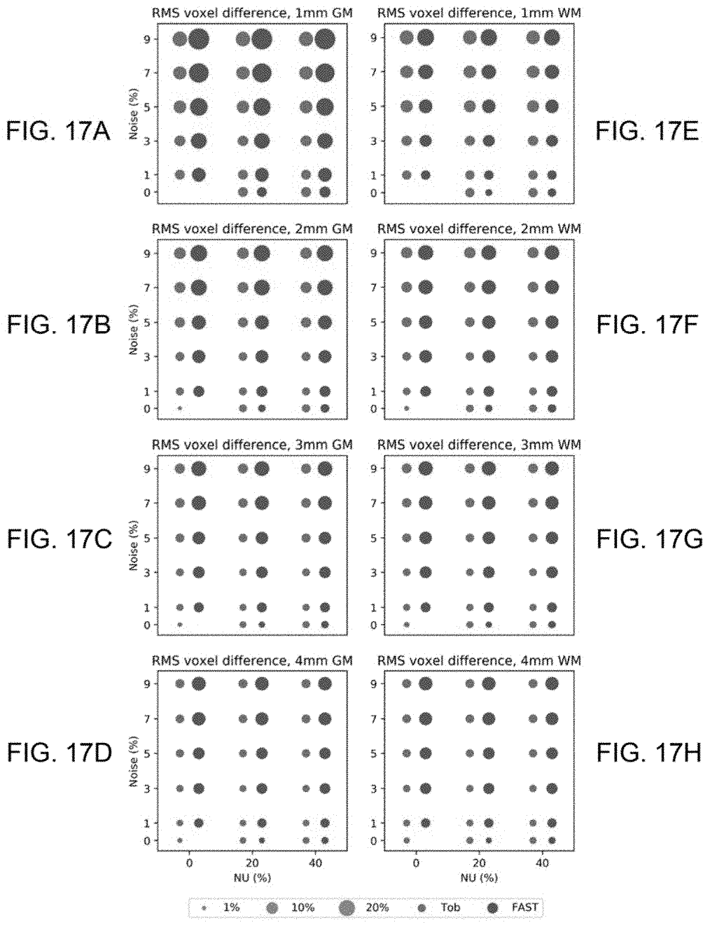

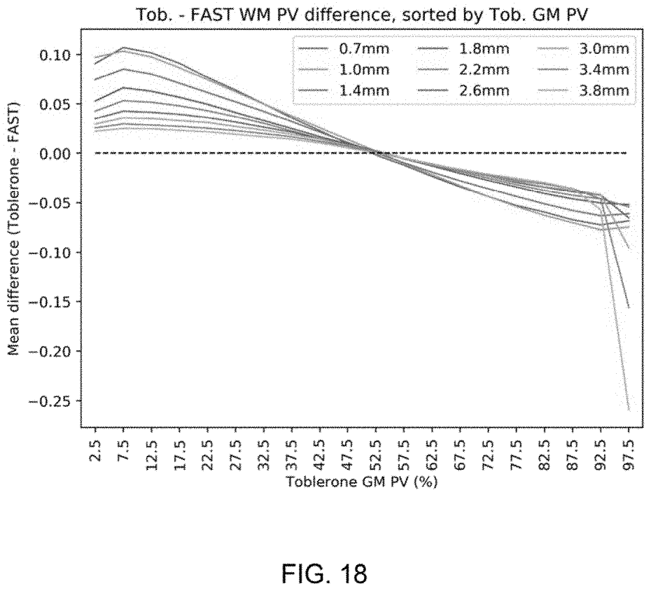

FIGS. 10A-10B show the RMS per-voxel difference in PV estimates at 3 mm voxel size as a function of noise and NU. Each method's 1 mm results at 0% noise 0% NU were used as the reference. Toblerone returned lower RMS voxel differences in both GM and WM at all levels of NU and noise except 0% noise 0% NU, a pattern that was repeated at other voxel sizes (FIGS. 17A-17H).

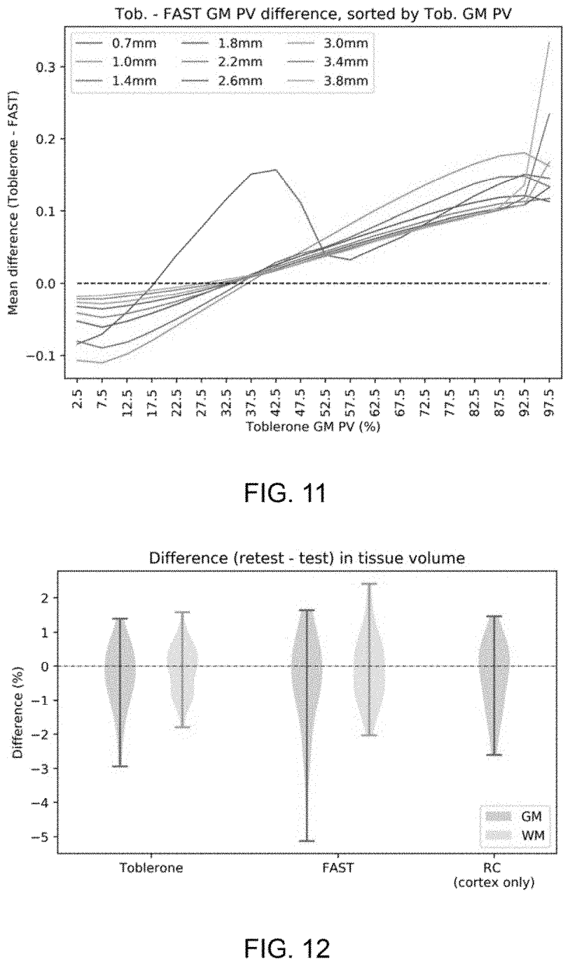

FIG. 11 shows the mean per-voxel difference between Toblerone and FAST's GM PV estimates as a function of Toblerone's GM PV estimate. Excepting the 0.7 mm result, the positive slope of each line shows that in voxels with a low Toblerone GM PV estimate, FAST was more likely to assign a higher value, and vice-versa at high Toblerone GM PV estimates. The strength of this relationship decreased with increasing voxel size. It should be noted that the 0.7 mm result was the only one not to make use of resampling (for all others, FAST's 0.7 mm estimates were resampled onto the target voxel grid).

FIG. 12 shows violin plots of inter-session difference (retest minus test) in tissue volume across the 45 subjects of the HCP dataset. PV estimates at 0.7 mm isotropic voxel size were used for this analysis. RC's GM result was for the cortex only. Both surface methods gave a tighter distribution than FAST, suggesting greater repeatability between sessions. All methods showed greater variability in GM than WM.

### VI. Discussion

Results from the simulated surfaces showed that Toblerone produced estimates with a comparatively low and consistent error. Although the RC method was able to perform similarly for GM, there was a clear advantage for Toblerone in WM. Results from the BrainWeb dataset suggested that a surface-based approach (the combination of FreeSurfer/FIRST and Toblerone) was more robust to random noise and field nonuniformity than FAST's volumetric approach. In particular, the BrainWeb results showed that the consistency of FAST's WM estimates suffered in the presence of these scanner imperfections. Finally, results from the HCP test-retest dataset showed that the surface-based approach provided better intersession repeatability in estimates of total tissue volume.

The use of resampling—unavoidable for volumetric methods which must transform PV estimates from a structural voxel grid to a functional voxel grid—degrades data quality in an unpredictable and highly localized manner. This chiefly arises due to so-called subvoxel effects, which may be illustrated via the following 1D example. Consider a row of voxels of size 1 mm that are to be resampled onto 1.4 mm voxels. A larger voxel overlaps evenly onto two smaller voxels, covering 0.7 mm of each. The resampled value will be the mean of the two smaller, on the implicit and unlikely assumption that the tissues within each are evenly distributed. Next, consider a row of 1 mm voxels that are to be resampled onto 3.4 mm voxels, whereby a larger voxel overlaps by 0.2, 1, 1, 1 and 0.2 mm onto smaller voxels. Again, the resampled value will be a weighted mean of the smaller voxels, but as the central three voxels are included wholly in the new voxel, the spatial distribution of tissues within these voxels is irrelevant and the assumption of even distribution can safely be made. As the ratio of output voxel size to input voxel size increases, the significance of subvoxel effects is therefore reduced.

It is extremely difficult to quantitatively measure the impact of resampling, particularly on non-simulated data. To do so would require the ability to express some volumetric reference data in an arbitrary voxel grid without making use of resampling, otherwise a trap of circular reasoning results. Nevertheless, such an analysis can be performed using the simulated surfaces presented earlier. The key conceptual difference is that the ground truth for this dataset is defined by a surface and can therefore calculated in any voxel grid without resampling.

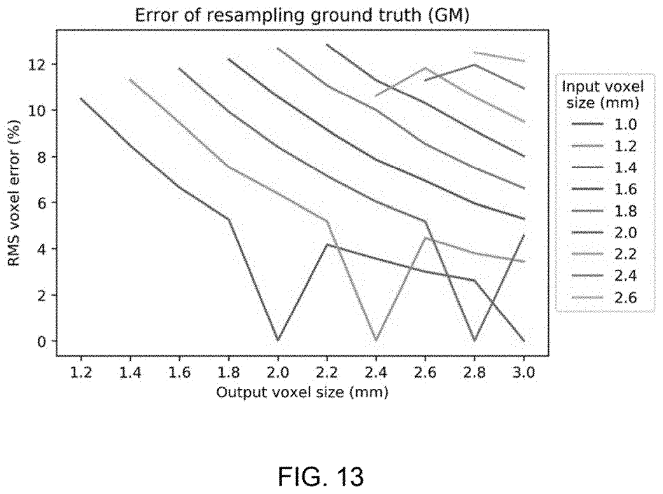

FIG. 13 shows the results of resampling ground truth results from the numerical method at each resolution to all other resolutions above the one in question (for example, the 1.4 mm truth was resampled to 1.6, 1.8, . . . etc.). At each voxel size, the resampled results can be compared to a ground truth that has been calculated without the use of resampling. RMS per-voxel error was then measured using the same mask as before, namely all voxels intersecting either surface of the cortex, as only these contain PVs. Multiple trends were seen: firstly, as the input voxel size increased, error at all output voxel sizes increased. Secondly, as the ratio of output to input voxel size increased, the error decreased. Finally, the error fell to zero when this ratio took an integer value. This is due to the use of perfectly aligned voxel grids in this work (which would not be the case with patient data) and is discussed in section IV.B. These phenomena likely explain the interesting behavior observed in various analyses, namely: the notches seen in FIGS. 8A-8B, as well as FIGS. 15A-15B and FIGS. 16A-16B (perfect voxel correspondence means no subvoxel effects); the 0.7 mm result in FIG. 11 (for all other sizes, resampling by a non-integer ratio of voxel size blurs the FAST results, reducing image contrast and the number of high GM PV voxels); and the lack of error observed in FAST's GM and WM results at 2, 3 and 4 mm voxel size, 0% noise 0% NU in FIGS. 10 and 17A-17H (again, perfect voxel correspondence with the reference set of 1 mm estimates). These considerations do not apply to surface-based methods as they do not make use of resampling.

A further advantage of surface-based methods concerns their application of transformations. Notwithstanding the fact that volumetric methods require resampling to transform data from one resolution to another, they also require it to apply a registration transformation between the structural voxel grid in which PVs are estimated and the functional voxel grid in which PVEc is to be performed. Once again, the impact of this upon data quality is highly localized and difficult to measure quantitatively. It can however be illustrated via the following experiment, illustrated in FIGS. 14A-14D. GM PV maps for the 0% noise 0% NU BrainWeb image were translated by 0.5 mm in each of the x,y,z axes. For FAST, this translation took the form of an affine transformation applied during a resampling operation. Significant blurring is seen, particularly around the edges of structures where there was previously good edge definition. As these edge voxels by definition contain PVs this is a particularly undesirable outcome. By contrast, blurring within a structure is of little consequence as the tissue is already homogenous. For Toblerone, this translation was performed by shifting the surfaces into the new reference voxel grid represented by the translation and then estimating PVs afresh with no noticeable reduction in edge definition.

In its native form, the RC method is unable to correctly handle voxels in which all three tissue types are present (due to the fact that it estimates for GM first and then assigns the remainder to either WM or non-brain). The impact of this is seen in the positive relationship between per-voxel error in WM and voxelsize in FIGS. 8A-8B. Resampling can help to minimize this error: at small voxel sizes, the probability of voxels containing three tissue types is smaller and so the error is minimized, but this does not hold true at larger voxel sizes. Accordingly, as output voxel size increases, it is increasingly beneficial to obtain PV estimates by resampling those from a smaller voxel size. Set against this, however, are the aforementioned problems introduced by resampling: when the ratio of output to input voxel size is small, subvoxel effects are significant and high per-voxel errors result (as seen in FIGS. 8A-8B). A threshold voxel value above which resampling is beneficial therefore results (at around 2 mm in the figure). The exact value of this threshold would be difficult to predict in the general case (in particular, the use of aligned voxel grids in this work is both highly significant and extremely unrealistic). By contrast, Toblerone is able to produce consistent estimates in all tissue classes at arbitrary voxel sizes without the use of resampling.

### VII. Conclusion

Toblerone is a new method for estimating PVs using surface segmentations. Unlike existing surface-based tools, it is not closely tied to any specific modality or structure and can therefore be adapted to multiple use cases (notably, providing PV estimates for the whole brain). It is able to operate at arbitrary resolutions without recourse to resampling, thereby avoiding the highly localized degradation of image quality that this process entails. Three datasets have been used for evaluation of the method. Results from simulated surfaces show consistently low errors at both the voxel and aggregate level, either matching or surpassing other surface-based methods. Results on simulated T1 images from the BrainWeb database show that a FreeSurfer/FIRST/Toblerone surface-based pipeline used as an alternative to FAST is more robust in the presence of random noise and field non-uniformity. Finally, results from the HCP test-retest dataset of 45 subjects show that the surface-based pipeline produces a tighter distribution of inter-session tissue volumes than FAST, suggesting the surface approach has greater repeatability. The magnitude of methodological differences observed in this work, and related conceptual questions concerning the difference in interpretation of subcortical tissue between surface and volumetric methods, will have implications for the wider process of PVEc.

### REFERENCES

[1] B. Fischl and A. M. Dale, “Measuring the thickness of the human cerebral cortex from magnetic resonance images,” Proc. Natl. Acad. Sci., vol. 97, no. 20, pp. 11050 LP-11055, September 2000.
[2] H. W. Müller-Gärtner, J. M. Links, J. L. Prince, R. N. Bryan, E. McVeigh, J. P. Leal, C. Davatzikos, and J. J. Frost, “Measurement of Radiotracer Concentration in Brain Gray Matter Using Positron Emission Tomography: MRI-Based Correction for Partial Volume Effects,” J. Cereb. Blood Flow Metab., vol. 12, no. 4, pp. 571-583, July 1992.
[3] I. Asllani, A. Borogovac, and T. R. Brown, “Regression algorithm correcting for partial volume effects in arterial spin labeling MRI,” Magn. Reson. Med., vol. 60, no. 6, pp. 1362-1371, September 2008.
[4] M. A. Chappell, A. R. Groves, B. J. Macintosh, M. J. Donahue, P. Jezzard, and M. W. Woolrich, “Partial volume correction of multiple inversion time arterial spin labeling MRI data,” Magn. Reson. Med., vol. 65, no. 4, pp. 1173-1183, 2011.
[5] D. W. Shattuck, S. R. Sandor-Leahy, K. A. Schaper, D. A. Rottenberg, and R. M. Leahy, “Magnetic resonance image tissue classification using a partial volume model,” Neuroimage, vol. 13, no. 5, pp. 856-876, 2001.
[6] B. Fischl, “FreeSurfer,” Neuroimage, vol. 62, no. 2, pp. 774-781, 2012.
[7] Y. Zhang, M. Brady, and S. Smith, “Segmentation of brain MR images through a hidden Markov random field model and the expectation-maximization algorithm,” IEEE Trans. Med. Imaging, vol. 20, no. 1, pp. 45-57, 2001.
[8] M. F. Glasser, S. N. Sotiropoulos, J. A. Wilson, T. S. Coalson, B. Fischl, J. L. Andersson, J. Xu, S. Jbabdi, M. Webster, J. R. Polimeni, D. C. Van Essen, and M. Jenkinson, “The minimal preprocessing pipelines for the Human Connectome Project,” Neuroimage, vol. 80, pp. 105-124, 2013.
[9] D. N. Greve, C. Svarer, P. M. Fisher, L. Feng, A. E. Hansen, W. Baare, B. Rosen, B. Fischl, and G. M. Knudsen, “Cortical surfacebased analysis reduces bias and variance in kinetic modeling of brain PET data,” Neuroimage, vol. 92, pp. 225-236, May 2014.
[10] D. N. Greve, D. H. Salat, S. L. Bowen, D. Izquierdo-Garcia, A. P. Schultz, C. Catana, J. A. Becker, C. Svarer, G. M. Knudsen, R. A. Sperling, and K. A. Johnson, “Different partial volume correction methods lead to different conclusions: An (18)F-FDG-PET study of aging,” Neuroimage, vol. 132, pp. 334-343, May 2016.
[11] B. Patenaude, S. M. Smith, D. N. Kennedy, and M. Jenkinson, “A Bayesian model of shape and appearance for subcortical brain segmentation,” Neuroimage, vol. 56, no. 3, pp. 907-922, June 2011.
[12] F. S. Nooruddin and G. Turk, “Simplification and repair of polygonal models using volumetric techniques,” IEEE Trans. Vis. Comput. Graph., vol. 9, no. 2, pp. 191-205, 2003.
[13] T. Akenine-Möller, “Fast 3D Triangle-Box Overlap Testing,” J. Graph. Tools, vol. 6, no. 1, pp. 29-33, 2001.
[14] C. B. Barber, D. P. Dobkin, and H. Huhdanpaa, “The Quickhull Algorithm for Convex Hulls,” ACM Trans. Math. Softw., vol. 22, no. 4, pp. 469-483, December 1996.
[15] C. Van Assel, G. Mangeat, B. De Leener, N. Stikov, C. Mainero, and J. Cohen, “Partial volume effect correction for surface-based cortical mapping,” Proc. Int. Soc. Magn. Reson. Med. Annu. Meet. Paris, 2017.
[16] D. L. Collins, A. P. Zijdenbos, V. Kollokian, J. G. Sled, N. J. Kabani, C. J. Holmes, and A. C. Evans, “Design and Construction of a Realistic Digital Brain Phantom,” IEEE Trans. Med. Imaging, vol. 17, no. 3, pp. 463-468, 1998.
[17] C. Cocosco, V. Kollokian, R. K. Kwan, G. B. Pike, and A. C. Evans, “BrainWeb: Online Interface to a 3D MRI Simulated Brain Database,” Third Int. Conf. Funct. Mapp. Hum. Brain, vol. 5, no. 4, p. S425, 1997.
[18] M. Y. Zhao, M. Mezue, A. R. Segerdahl, T. W. Okell, I. Tracey, Y. Xiao, and M. A. Chappell, “A systematic study of the sensitivity of partial volume correction methods for the quantification of perfusion from pseudo-continuous arterial spin labeling MRI,” Neuroimage, vol. 162, pp. 384-397, November 2017.

### Example 2

1. Introduction

As noted above, partial volume effects (PVE) arise due to low spatial resolution of images in relation to structures of interest. This can result in voxels containing multiple tissue types, called partial volumes. PVE are a source of confound for the analysis of functional data from BOLD, ASL [1] and PET as they present a mixed source problem: there are multiple tissues in each voxel (sources) but only one measured signal. Un-mixing the signal to recover the individual sources is called PVE correction (PVEc).

PVEc requires per-voxel estimates of PVs. Multiple methods have been developed: e.g., spatially regularized variational Bayes (spatial-VB) for ASL [2], Muller-Gartner for PET [3].

There is not currently a consensus on how PVE should be corrected for (PVEc), nor conclusive evidence of benefits, despite clear theoretical justification for this step [1].

PVEc requires estimates of grey matter (GM), white matter (WM), and non-brain tissue (including cerebrospinal fluid, CSF) PVs in each voxel; usually these are estimated alongside segmentation in a volumetric manner, e.g. with FAST [4]. PVEc is sensitive to the PV estimates used [1].

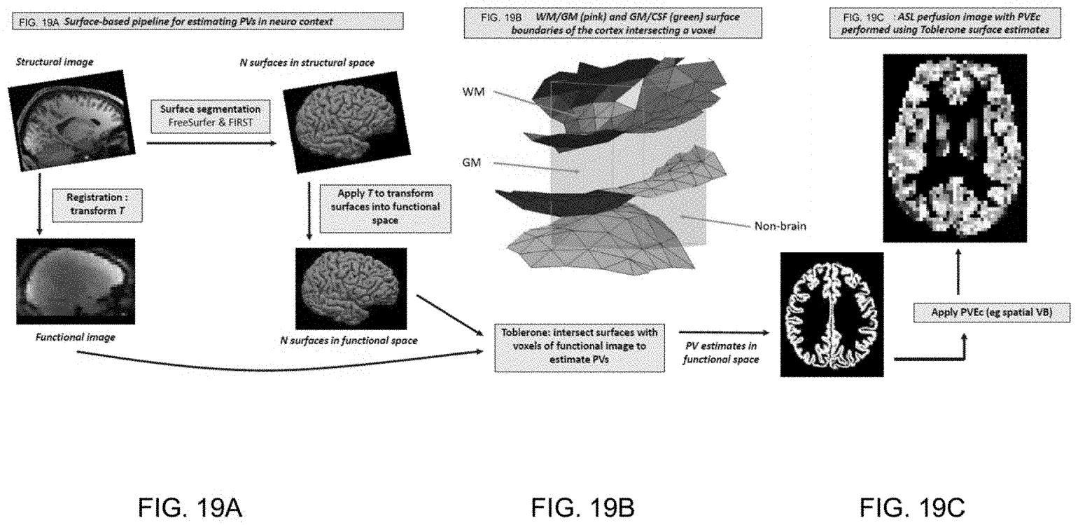

The conventional approach to PV estimation for neuroimaging is via volumetric MRI segmentation tools such as FSL's FAST [4]. A typical pipeline for PVEc of ASL is shown in FIG. 19A.

2. The Alternative: A Surface-Based Approach

Surface-based segmentation is well-established for complex geometries (e.g., FreeSurfer [5] for the cerebral cortex, FSL FIRST [6] for subcortical structures).

PV estimates can be obtained from surface segmentations by considering the geometry of intersection between surfaces and individual voxels. This is the purpose in this example of Toblerone, which has been developed for ASL in a neuroimaging context but is highly general in nature and can be adapted for other uses (e.g. BOLD, PET).

In various aspects, Toblerone is purely geometric: given a surface intersecting a voxel, what is the volume within the voxel bounded by the surface? Such is illustrated in FIG. 19B.

An alternative pipeline for estimating PVs from surfaces via Toblerone in neuro context is shown in FIGS. 19A-19C.

3. Evaluation

In this example, methods according to the present embodiment were evaluated on two datasets: i) simulated cortical surfaces: a pair of spheres with sulci and gyri for which ground truth exists and ii) 50 subjects drawn from the Human Connectome Project (HCP) [7].

Comparison was made against two other tools: i) the ribbon-constrained method (RC) designed by the HCP for BOLD data [7] and ii) NeuropolyPVE, designed for structural resolution MRI [8]. Neither of these methods were designed specifically for use with ASL so they were modified accordingly. FSL's FAST was used on the HCP T1w structural images to provide conventional estimates.

PVs were estimated for GM, WM and non-brain; errors were measured on a per-voxel and aggregate basis. For the HCP dataset there is no ground truth so Toblerone's estimates were used as the reference point for comparison with other methods.

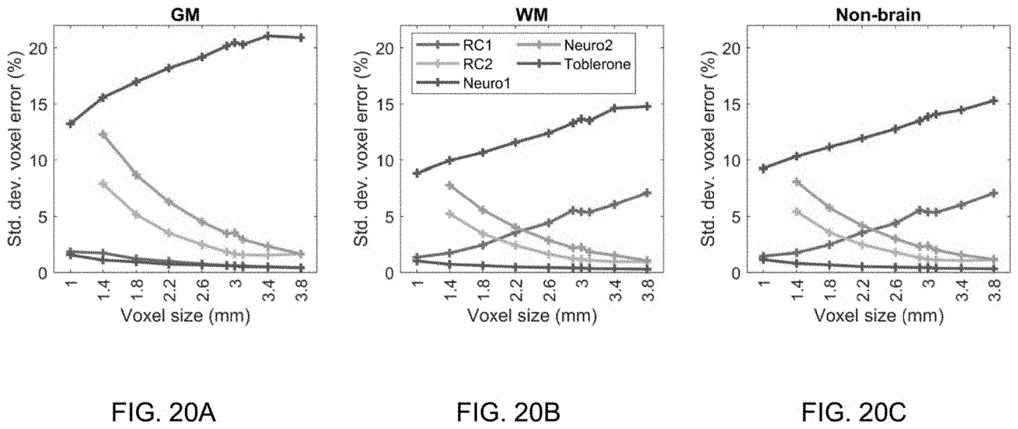

Simulation results showed Toblerone had the lowest or close to lowest error at all resolutions and in all tissues (FIGS. 20A-20C).

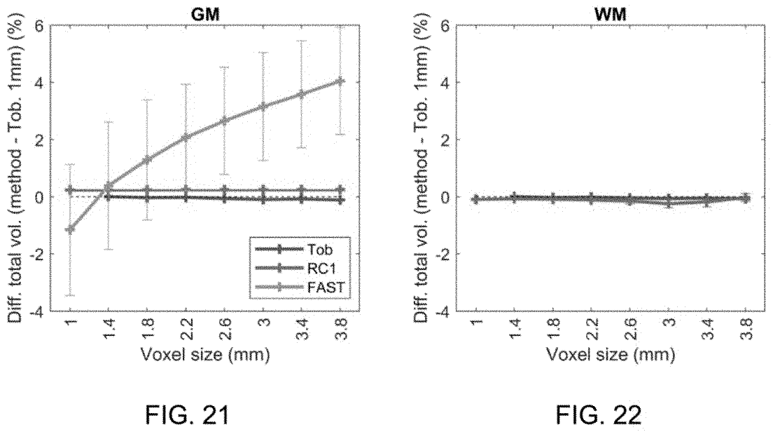

HCP results showed consistency in relative performance between methods compared to simulations and important differences in GM PV estimates v. FAST (FIG. 21) and in VM (FIG. 22).

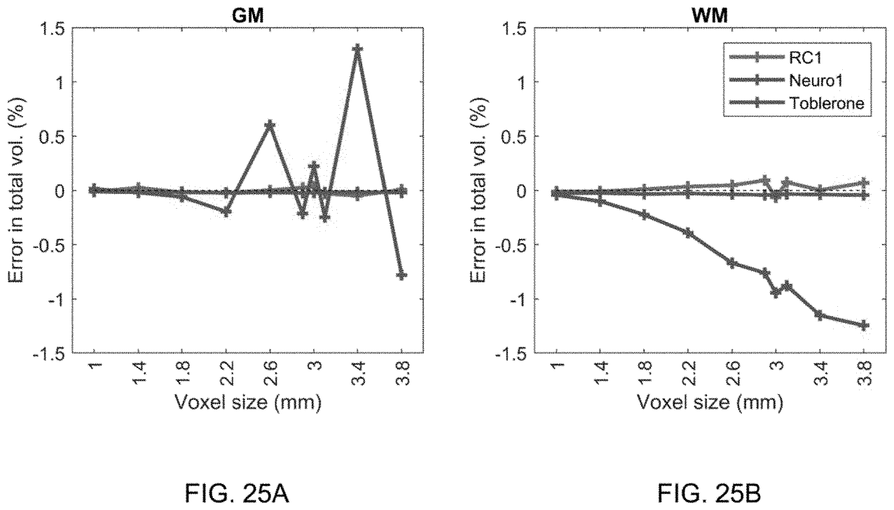

FIGS. 25A-25B are graphs depicting error in total tissue volume across resolutions.

4. PVEc of an ASL Dataset

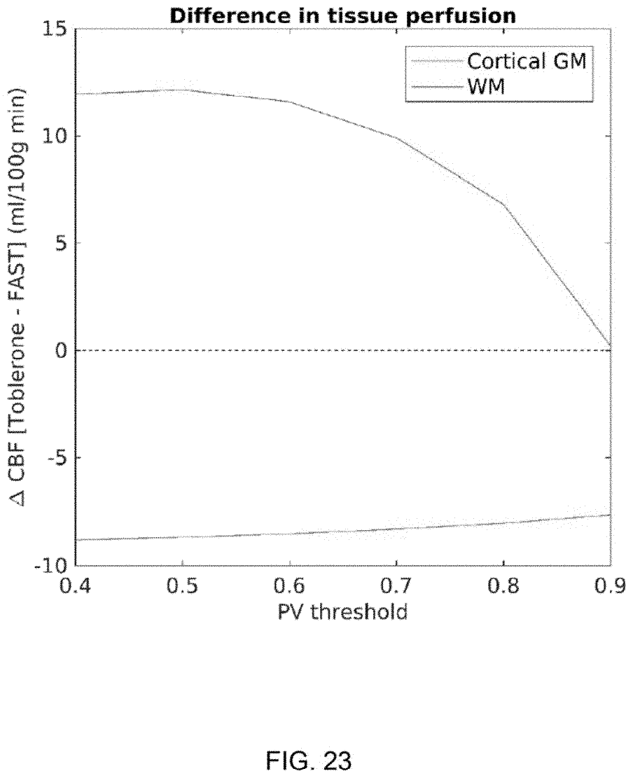

Difference in PV estimates compared to FAST will have implications for PVEc [1]. By way of illustration: Multi-PLD ASL dataset: 7 subjects, 6 PLDs, 34 acquisitions total, as in [9]. FSL's oxford_asl [10] pipeline used to perform brain extraction via BET, registration via FLIRT-BBR, label-control subtraction, model inversion via BASIL [11] and calibration using reference CSF region MO value. PVEc were then performed via spatial-VB [2] using i) volumetric PV estimates (FAST) and ii) Toblerone's surface estimates (via FreeSurfer) to give 34 pairs of images. Mean GM and WM CBF were evaluated across all images for each method masked at various thresholds. GM masked to cortex-only using subject-specific cortex mask. The present Toblerone surface method leads to ˜10 ml/100 g min increase in cortical GM CBF and ˜10 ml/100 g min decrease in WMCBF across different thresholds (FIG. 23).

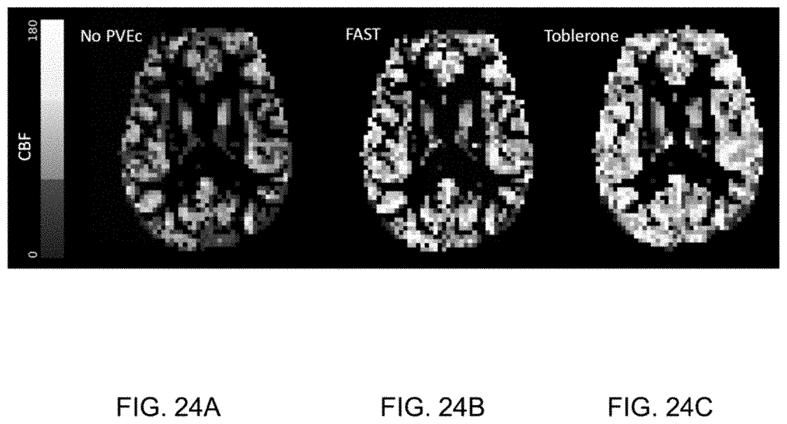

An example PVE corrected image from this dataset is shown in FIGS. 24A-24C.

5. Conclusion

The present Toblerone surface-based segmentation is an alternative approach to conventional volumetric tools. It can be more suitable for complex structures such as the cortex, and in turn can provide better PV estimates.

Toblerone provides a general and flexible approach to PV estimation using surface segmentations. Designed with ASL in mind it can be used with other modalities.

Validation performed on simulated surfaces shows low error across resolutions; validation on 50 HCP subjects shows consistency between resolutions.

Compared to existing PV estimation tools, the present surface methods produce different and improved results which in turn has implications for PVEc. For example, on an ASL dataset, a mean increase of 10 ml/100 g min in cortical GM perfusion was observed compared to conventional PVEc with FAST.

### REFERENCES

[1] M Zhao et al, 2017, NeuroImage
[2] M A Chappell et al, 2011, Mag Res. Med. 65(4):1173-1183.
[3] H W Muller-Gartner et al J Cereb Blood Flow Metab. 1992; 12(4):571-83
[4] Y Zhang et al, 2001, IEEE Trans Med Imaging
[5] B Fischl et al, 2012, NeuroImage
[6] B Patenaude et al, 2011, NeuroImage, 56(3):907-922, 2011.
[7] M Glasser et al, 2013, NeuroImage
[8] C Van Assel et al, 2017, Proc. ISMRM annual meeting
[9] M Mezue et al, 2014, J Cereb Blood Flow Metab, 34 1919-1927
[10] https://fsl.fmrib.ox.ac.uk/fsl/fslwiki/BASIL
[11] M A Chappell 2009 IEEE Trans on Signal Proc 57(1):223-236.

### Example 3

In this example, Toblerone uses the inner (WM/GM boundary) and outer (GM/CSF) surfaces of the cortical ribbon and an image for which PV estimates are required.

Voxels are processed individually via recursion, results are aggregated to give an estimate in range [0 1] for each voxel of GM, WM and non-brain (including CSF).

1. Data and Comparator Methods

Simulated surfaces and 50 surfaces from the Human Connectome Project (HCP) [4]. Two other surface-based PV estimation methods [4,5] were used for comparison.

FSL's FAST was used on the HCP structural images to compare the surface-based workflow with the volumetric equivalent. All methods run at voxel resolutions of 1 mm to 3.8 mm isotropic in steps of 0.4 mm.

2. Evaluation Metrics

Simulation: error was measured at the voxel-level as difference to ground truth and at the aggregate level as difference in total estimated volume.

HCP data: ground truth cannot be defined so Toblerone's estimate was used as the reference point. The same metrics were then used as in the simulations.

Voxel-wise results are presented in native PV units (10% corresponds to a PV of 0.1), aggregate level results are presented in percentage difference of reference value.

3. Results and Discussion

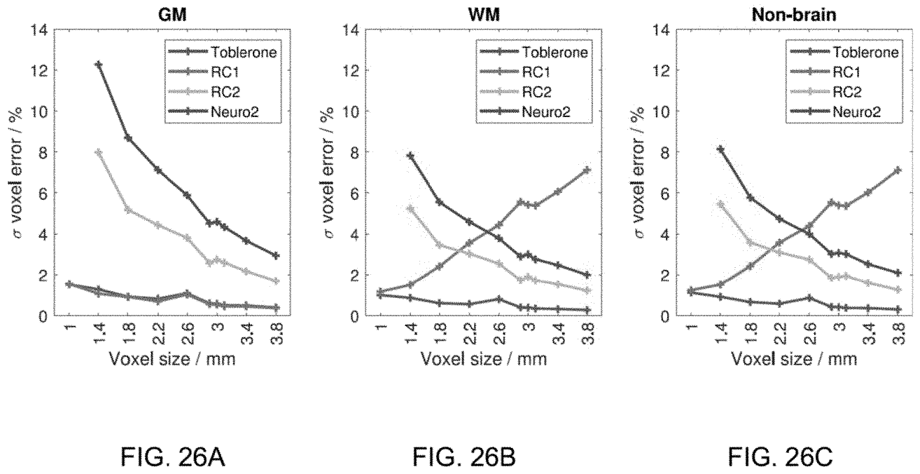

FIGS. 26A-26C are graphs of Simulation results: standard deviation of voxel-wise error. Toblerone estimates had the lowest, or close to lowest, std. dev. of voxel-wise error in all tissue types (GM, FIG. 26A; WM, FIG. 26B; and non-brain, FIG. 26C) at all resolutions, particularly in WM and non-brain.

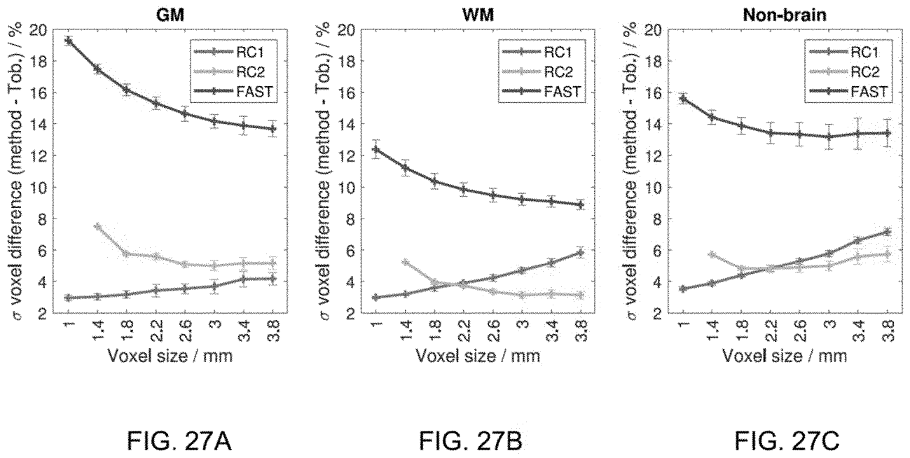

FIGS. 27A-27C are graphs showing HCP results, mean across subjects of standard deviation in voxel-wise difference to Toblerone's estimate (GM, FIG. 27A; WM, FIG. 27B; and non-brain, FIG. 27C). The differences between RC1/RC2 (surface-based methods) and Toblerone were comparable to those in the simulations, which suggested that the surface-based methods were behaving consistently on the simulations as on the HCP data. The voxel-wise differences between FAST and Toblerone were much more significant at all resolutions (e.g. 14% standard deviation of difference at 3 mm in GM).

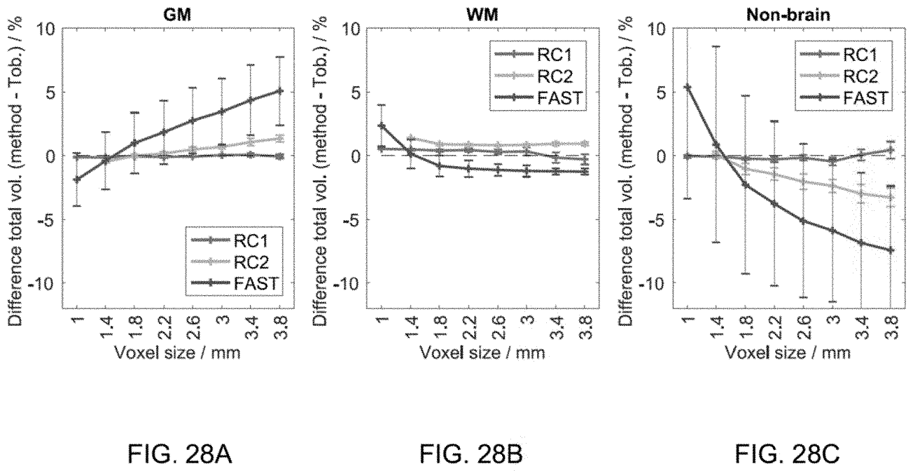

FIGS. 28A-28C are graphs showing HCP results, mean across subjects of difference in total estimated tissue volume to Toblerone (GM, FIG. 28A; WM, FIG. 28B; and non-brain, FIG. 28C). All methods showed agreement at small voxel sizes but FAST in particular diverged with increasing size. Along with the results in FIGS. 27A-27C, this suggests that FAST and Toblerone broadly agreed on overall tissue volume at fine resolutions but disagreed on its distribution across voxels. As PVEc is a voxel-wise operation that is sensitive to error in PV estimates [1], these differences will have implications for PVEc.

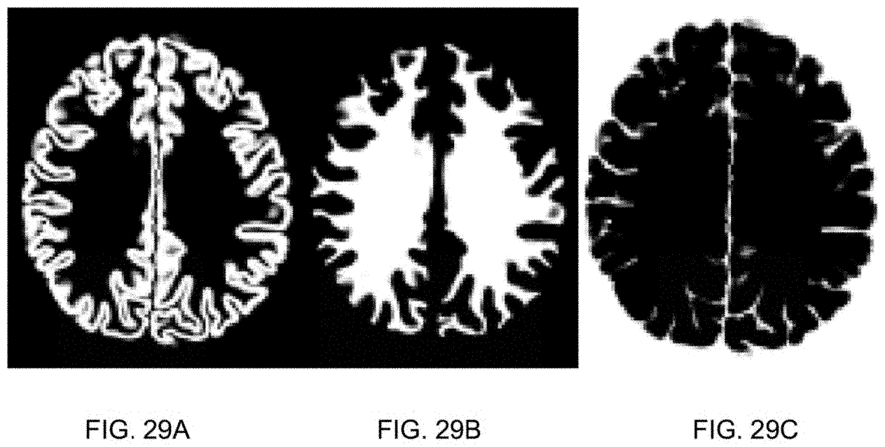

FIGS. 29A-29C are PV estimates for subject 100307 of the HCP at 1.4 mm isotropic resolution in GM (L, FIG. 29A), WM (C, FIG. 29B) and non-brain (R, FIG. 29C).

4. Conclusion

Toblerone provides a new surface-based method for estimating cortical PVs. Simulations show that estimation error is consistently low across a range of resolutions. Results from the HCP dataset show there can be significant differences in estimates from surface and volume methods; this will have implications for PVEc.

### REFERENCES

[1] M Zhao et al, 2017, NeuroImage
[2] Y Zhang et al, 2001, IEEE Trans Med Imaging
[3] B Fischl et al, 2012, NeuroImage
[4] M Glasser et al, 2013, NeuroImage
[5] C Van Assel et al, 2017, Proc. ISMRM

### Example 4

1. Introduction

Described herein in this example are methods of imaging to infer information about underlying physiological processes, in particular the use of arterial spin labeling (ASL) functional magnetic resonance imaging (fMRI) to measure perfusion (blood delivery) in the brain.

Structural MRI generates images showing a picture of what is there. Three tissue types are denoted, from black to white, respectively, are cerebrospinal fluid (CSF), grey matter (GM), and white matter (WM).

Functional MRI (fMRI) generates an image of what is happening. Such images are dynamic and not static. Yellow corresponds to high blood flow in that region, red to low.

Examples of useful fMRI applications include imaging patients having or suspected of having Alzheimer's disease (AD) or dementia. For these conditions, there is reduced blood flow, particularly to the cortical GM, indicated by a decrease in yellow in fMRI images. There is also a loss of cortical GM (cortical atrophy). There remains a question of causality that is somewhat ambiguous—which drives which?

2. Diagnosis Via fMRI

Measurements of blood flow in cortical GM provide a good predictor of onset of AD and dementia. Studies suggest this diagnosis route can spot onset 18-24 months in advance of existing techniques. Early diagnosis can lead to more effective treatment, although treatment remains a huge challenge.

3. MRI: From Pixels to Voxels

Two-dimensional images are formed of pixels: squares. They are too small to be noticed, but they are actually a summation of whatever happens to be at that point in space.

The volume pixel (voxel) is a cube in three-dimensions. The same idea underlies that voxel that underlies the pixel: the brightness is a summation of whatever is inside the cube.

4. Functional Resolution

The voxels on a functional image are comparatively enormous, which is an unavoidable consequence of preserving signal-to-noise ratio in functional images. Each voxel reflects the blood flow of whatever tissue is there. But, if there is more than one tissue in the voxel (all but guaranteed) then the value reflects blood flow of all the tissues together. This is not desired.

5. The Partial Volume Effect

The voxels in the image contain partial volumes of each tissue. So, the recorded value in each voxel is a mixture of the true values from each individual tissue. The values for each tissue are desired, however, and not the overall values. This creates a mixed-source problem requiring a solution of how to de-mix the signal to work out the individual sources (i.e. contribution of blood flow in each tissue type leading to the overall summed signal in the voxel).

6. Confounding Effects

Take the following two examples:

Case 1: 50% healthy WM @ 20 units, 50% healthy GM @ 60 units. Overall voxel value is (0.5×20)+(0.5×60)=40 units.

Case 2: 100% unhealthy GM @ 40 units. Overall voxel value is (1×40)=40 units.

There is a need to distinguish between the two.

7. Partial Volume Estimation

To demix the signal, there is a need to know how much GM, WM, and CSF there is in each voxel. But the shape of the brain, especially around the surface which is of importance, makes answering this question very difficult. Perfect solutions do not exist, but it is possible to approximate with cortical surface reconstructions, which capture the surface geometry well. Cortical surface reconstruction, however, is an incredibly resource-intensive process, and can take up to 20 hours even on a powerful computer.

FIG. 4 demonstrates a complex voxel, on which de-mixing is particularly desired. 8. The Toblerone Method

In any one or more aspects herein, for each voxel through which one or both of the surfaces pass, Toblerone determines how much GM/WM/CSF is there. In an embodiment, an approach taken by Toblerone is adaptive recursion, aka “divide and conquer”, but done intelligently. Each voxel is divided into subvoxels, eg. 3, in each dimension, which in this example results in 27 subvoxels in total (3\hat{ }3), but in other examples can be subdivided into a different number of subvoxels. Each are then processed, and the results are then aggregated (summed) back together.

In the case that the subvoxels are too complicated, they can be subdivided. For example, the subvoxels can be further subdivided into 125 sub-subvoxels, or another number of sub-subvoxels.

This is hugely intensive and expensive. For example, 100 k normal voxels on an fMRI image->338 million sub-subvoxels in the worst case (which in turn requires 140 billion dot products . . . ). The present Toblerone presents a solution to this problem.

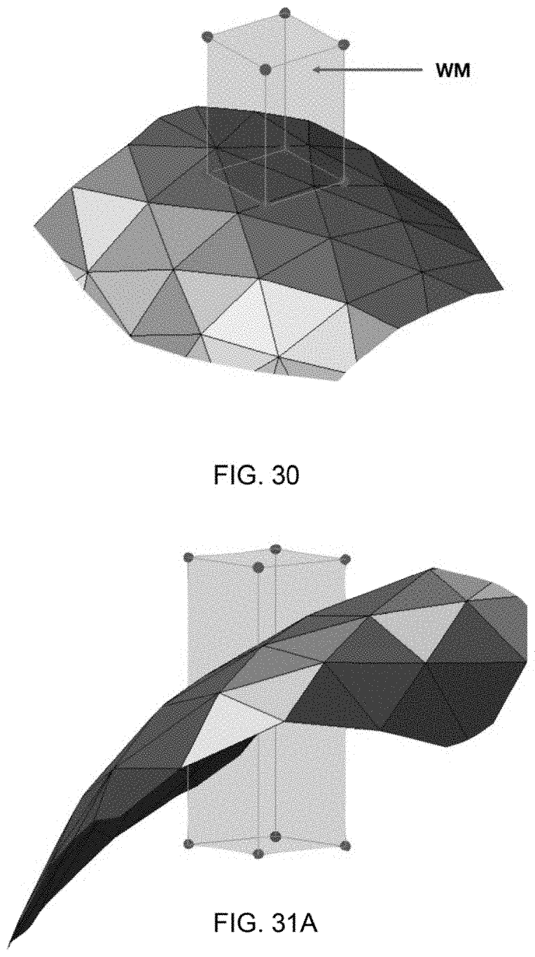

A simple case is illustrated in FIG. 30. There is no intersection, so the whole subvoxel is assigned (WM in this example).

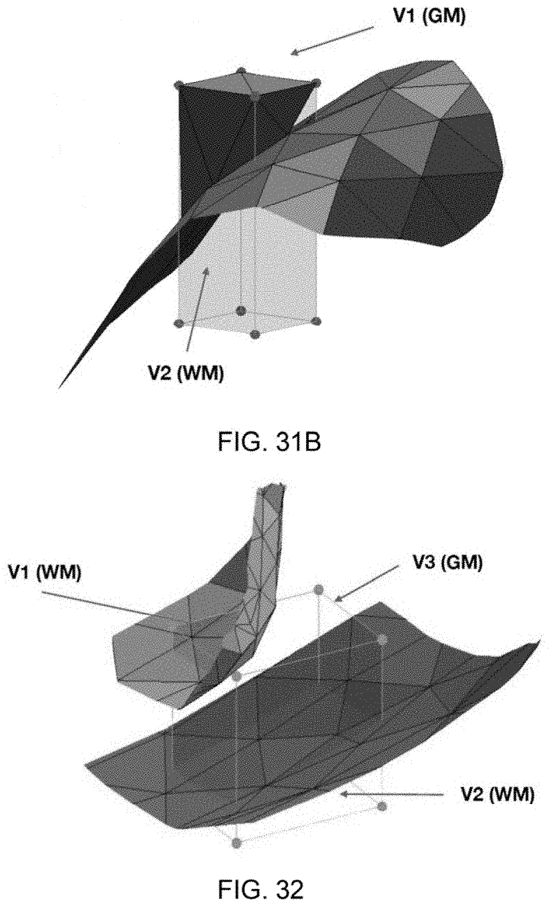

Another example is provided in FIGS. 31A-31B. One surface intersection->convex hull algorithm to find the V1, then do V2=1−V1 to get the other side.

FIG. 32 provides another simple example. One intersection of each surface->use convex hulls twice and then V3=V−V1−V2.

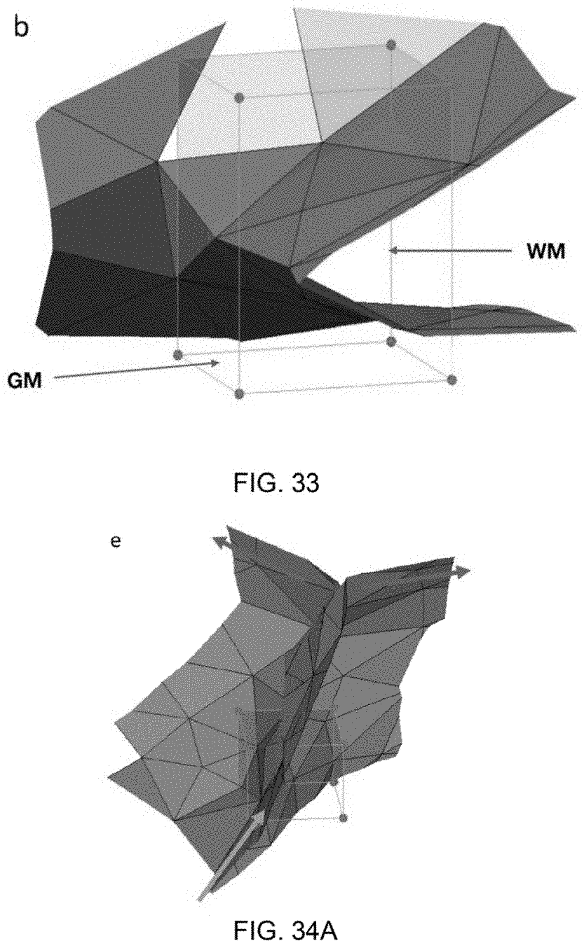

FIG. 33 provides a complicated example. High curvature of the surface (i.e., a fold within the subvoxel)->use recursion again, subdividing the subvoxel.

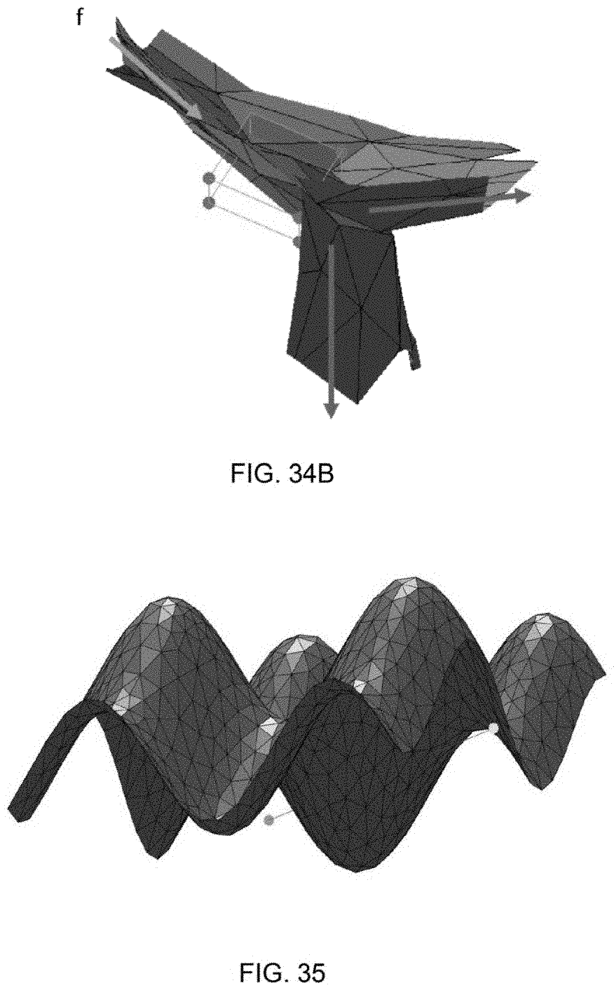

FIGS. 34A-34B show another complicated example. Multiple intersections of the same surface are too complex->use recursion again, subdividing the subvoxel.

### Example 5

1. Abstract

In this example, Toblerone is used for estimating partial volumes around the cortical ribbon using the cortical surface as input. Validation of this method has been performed on two surface phantoms and a comparison has been made to two existing surface-based partial volume estimation methods; the results show that Toblerone provides estimates with low error across a range of voxel resolutions, with a particular advantage over other methods for WM and CSF. This will be of use in better performing partial volume correction, a recommended step for functional neuroimaging techniques such as ASL and BOLD. Furthermore, the nature of Toblerone is general enough that it could feasibly be used in other contexts where surfaces are available.

2. Introduction

Partial volume effects are a consequence of the low spatial resolution of functional images compared to the structures of interest in the brain. In the case of perfusion quantification via arterial spin labelling (ASL, for which this method was developed; discussion will focus on this technique), voxels typically have side lengths of 3-4 mm whereas the mean thickness of the cortical ribbon is around 2.5 mm [1]. The majority of voxels in a functional image therefore contain multiple tissue types (white matter, WM, grey matter, GM, and cerebrospinal fluid (CSF). The proportions of each tissue in a given voxel are termed partial volumes (PVs) and give rise to a mixed-source problem for quantifying the physiological processes that drive the signal in each voxel; namely that there are multiple sources (tissues) but one signal (a weighted sum according to the volumes of tissue). These are the partial volume effects (PVE). Though there is consensus that PVE present a “substantial and often overlooked issue” for ASL, there is currently no such consensus on how partial volume correction (PVC) should be performed, nor evidence of “consistent benefits” arising from it [2]. Nevertheless, the significance of PVE are increased when the expected changes in perfusion being examined for are subtle, as is the case in neurodegenerative disease [3].

Any form of PVC requires estimation of the PVs present in each voxel as a first step. Such estimates are readily obtained by exploiting the high resolution of structural MR images; as many small structural voxels comprise each functional voxel, the composition of the latter can be obtained by classifying the tissue types of the former. It should be noted that this latter step—brain segmentation—remains a significant challenge, particularly around areas of fine detail such as the cortex, and the situation is not helped by the lack of ground truth in this context. The majority of conventional PV estimation methods are usually intensity-based mixture models in the tradition of Santago and Gage [4], though some also make use of spatial information via priors and the use of Markov random fields [5, 6] to enforce anatomically realistic local continuity of tissue types.

Recently, support for surface-based analysis of neuroimaging data (as opposed to traditional volumetric analysis) has grown [7]. Although methods to extract the cortical surface from structural MR images are not new (FreeSurfer [8] is well-established, amongst others), the notion of projecting volumetric data onto the cortical surface prior to analysis is. FreeSurfer is well suited to performing segmentation around the cortex: though it is intensity-based in the sense that the surface is placed according to local intensity gradients, the extra constraint of tissue continuity along the surface and various other enhancements improve accuracy to the point that pathology-induced changes in cortical thickness can be detected down to 0.25 mm [8]. This is in contrast with a tool such as FAST which does encourage local continuity via MRFs but does so isotropically in each direction. Accordingly, it is possible to use the pial (CSF/GM boundary) and white (GM/WM boundary) surfaces produced by FreeSurfer, respectively the outer and inner surfaces of the cortical ribbon, to estimate PVs by considering the intersection of these surfaces through relevant voxels. Being a purely geometric question, namely, given a pair of surfaces that intersect a voxel, what is the volume bounded by each that is contained within the voxel. This is a fundamentally different approach to existing methods.

3. Theory

Within the field of computer graphics, the process of quantifying the volume contained within a surface is called voxelisation. Due to the complexity of this problem in the general form, and particularly given the piecewise planar nature of most surfaces, this is a discrete operation in terms of volume elements (voxels). Any voxelisation algorithm must be able to test an arbitrary point in space and determine if it lies within a given surface; from these volumes are built up. The ray intersection test is often used for this; Nooruddin and Turk [9] outline two forms for contiguous (\water-tight”) and slightly non-contiguous (containing small holes) surfaces.

Parity checking. For a contiguous surface, any point can be classified as interior or exterior by projecting a ray in any direction from that point and counting the number of intersections made with the surface. If the point is interior to the surface then there will always be one more point of exit than entry and hence there will be an odd number of total intersections. Conversely, any ray originating from a point outside that enters the surface must eventually leave, yielding an even number of intersections.

Orthographic projection. In order to deal with non-contiguous surfaces, the parity count method can be generalized by projecting a ray in multiple directions and recording the results from each. Points are then classified according to majority voting across the results; Nooruddin and Turk [9] report that projection from 13 different directions provides enough coverage to give reliable results.

This approach can be computationally expensive: to voxelise a surface into a volume with a linear resolution of n sampling points per unit length requires n3 tests per unit volume. Furthermore, as each ray must be tested for intersection against each triangle present in the surface, complexity scales directly with increasing surface size (the surfaces produced by FreeSurfer comprise ˜250 k triangles per hemisphere). Accordingly, traditional voxelisation methods were deemed impractical for use in this context.

The approach adopted in Toblerone herein is to only use the portion of a surface that actually intersects a given voxel (referred to as the local patch) for ray intersection testing (see FIG. 35). As by definition the local patch is non-contiguous (it is a topological plane, not a sphere), the ray intersection test has been extensively modified; neither parity checking nor orthogonal projection are applicable in this case. FreeSurfer surfaces are defined such that the inward normal can readily be found at any vertex and by utilizing the dot product between the local normal and a projected ray, Toblerone is able to distinguish between points of entry and exit to the surface, which is then used in conjunction with a parity test to classify points as interior or exterior to the local patch (the ray is drawn from the point under test to a “root point” known to lie within the surface, which resolves the ambiguity of testing against a non-contiguous surface). Finally, in order to minimize computational expense (important given that the optimizations used by Nooruddin and Turk [9] cannot be applied), the approach whereby all space is isotropically divided up into sampling volumes that are individually tested is not used; instead, Toblerone aims to test the minimal number of points required to identify and quantify whole regions via the use of convex hulls, reverting to brute force only where necessary.

4. Method

Toblerone uses the white and pial (hereafter inner and outer) surfaces provided by FreeSurfer and a voxel coordinate system (taken from a functional image that requires correction). The output is an image the same space with partial volume estimates in the unit interval for each tissue in each voxel. Toblerone does not require that the input surfaces be contiguous nor that they have vertex correspondence.

The first step identifies the local patches for each voxel (the portions of each surface intersecting a given voxel) by mapping all surface nodes and their respective triangles to their containing voxels. A two-neighbor dilation around the outer limit of the patch is applied to improve the reliability of the ray intersection test by presenting a larger patch to test against (In particular, this ensures that the patch divides space within the voxel into two distinct regions. If this step is not applied, a small gap can exist between the bounds of the voxel and the patch, and should a ray used for intersection testing pass through this gap, incorrect classification will occur). In order to capture voxels through which a plane of the surface passes but in which no surface nodes lie triangle midpoints are also calculated and mapped to voxels.

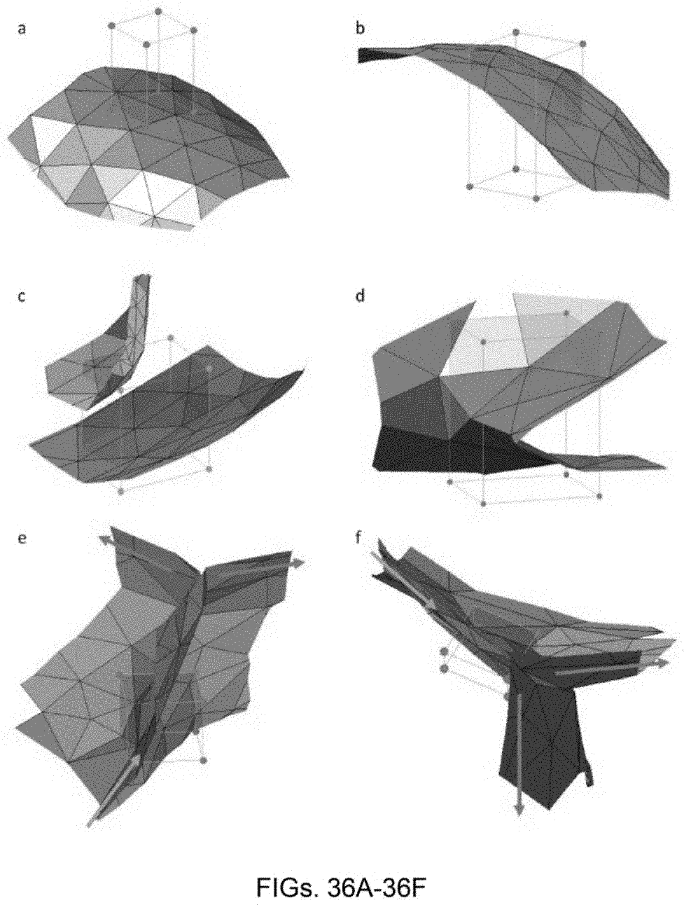

The geometry of either surface within a voxel is frequently complex. Amongst other things, the surface may exhibit high curvature or intersect the voxel multiple times (for example, it is common for the sides of a sulcus passing through a voxel to appear as separate patches of surface [8], see FIGS. 36E-36F). Accounting for the many possible surface configurations requires numerous specific tests that rapidly become excessively complex. The approach taken in Toblerone is therefore to divide and conquer the problem via recursion (for example, subdivision of voxels and subvoxels, as needed). As the length scale of the voxel decreases these difficulties are reduced; for example, the probability of a surface intersecting a voxel multiple times will decrease. Each voxel of the functional image is therefore subdivided isotropically by a supersampling factor (a function of voxel size) to yield a number of first-level subvoxels (for example, 33=27). Each subvoxel is then processed according to the following framework:

If the edge vectors of the subvoxel do not intersect either surface, a whole-tissue type classification can be performed by testing the vertices of the subvoxel. For example, if all the vertices lie interior to the outer surface but exterior to the inner, the subvoxel is within the cortex (GM). See FIG. 36A.

If the edge vectors of the subvoxel intersect only one surface then the subvoxel contains two tissues, the PVs of which will be estimated in one or more aspects using convex hulls. In any two-tissue voxel, an intersecting surface that encloses a convex volume on one side will by definition enclose a concave volume on the other; though it is not always the case that a convex volume exists within a subvoxel it is at least true that one volume is closer to being convex than the other. In order to minimize the error associated with using a convex hull algorithm to quantify a potentially non-convex volume it is important to identify which one is closer to being convex than the other. The proxy measure used for this is the number of subvoxel vertices lying interior or exterior to the surface: the convex hull will always be taken on the side on which fewer vertices lie as this is more likely to be genuinely convex, and even if it is not, the error of miscalculation will be smaller than would otherwise be the case (because the resulting hull is smaller). The other PV is then found by calculating V−Vₐ, where V, is the hull volume and V the subvoxel volume. The points around which the hull is calculated are the subvoxel vertices on the side of interest, the surface nodes lying within the subvoxel, and the points of intersection of the edge vectors of the subvoxel into the surface. FIG. 36B.

The use of convex hulls extends to three-tissue voxels, except that it is always the case that the hulls corresponding to WM and CSF are calculated first and GM volume is calculated by V−Vₐ−V_{b} where Vₐ and V_{b} are the hull volumes and V the subvoxel volume. FIG. 36C.

If either surface is folded within the subvoxel (identified by multiple intersection of any edge or diagonal vector with the surface) then recursion is used. Although a fold would naturally enclose a convex hull, it is difficult to reliably identify where it lies and calculate the appropriate hull. It is therefore safer to fall back on recursion. FIG. 36D.

If either surface intersects the voxel multiple times (the surface nodes lying within the voxel can be separated into unconnected point clouds) then recursion is again used. This situation occurs for example when opposite banks of a sulcus pass through a voxel [8]. Although ray intersection testing is reliable in this situation (it is required for recursion of any form), forming convex hulls is not (it is difficult to identify the points that should be included), so again it is safer to use recursion. FIG. 36E-36F.

Recursion of any subvoxel is performed by further supersampling at a factor of 5 into second-level subvoxels. At typical functional resolution of ˜4 mm voxel side length, with supersampling factor of 5 at the first level, this is equivalent to sampling at a volume scale of 1/(5³)²=1/15625. Subvoxels at the second level are always assigned a whole tissue type according to a ray intersection test of their centre point, regardless of whether the surface intersects or not. This is appropriate because the size of these subvoxels means that any partial volumes will be negligible. However, it should be understood that the supersampling factor of 5 can be adjusted up or down depending upon the dimensions of the surface involved.

Finally, all other voxels not intersecting the cortical ribbon are assigned a whole-tissue using a ray-intersection test performed on their centres to the triangles of closest nodes of either surface. A logical mask of the cortical ribbon is output alongside the PV estimates in all voxels in order to facilitate the merging of results from multiple estimation techniques.

5. Validation and Comparison to Existing Methods

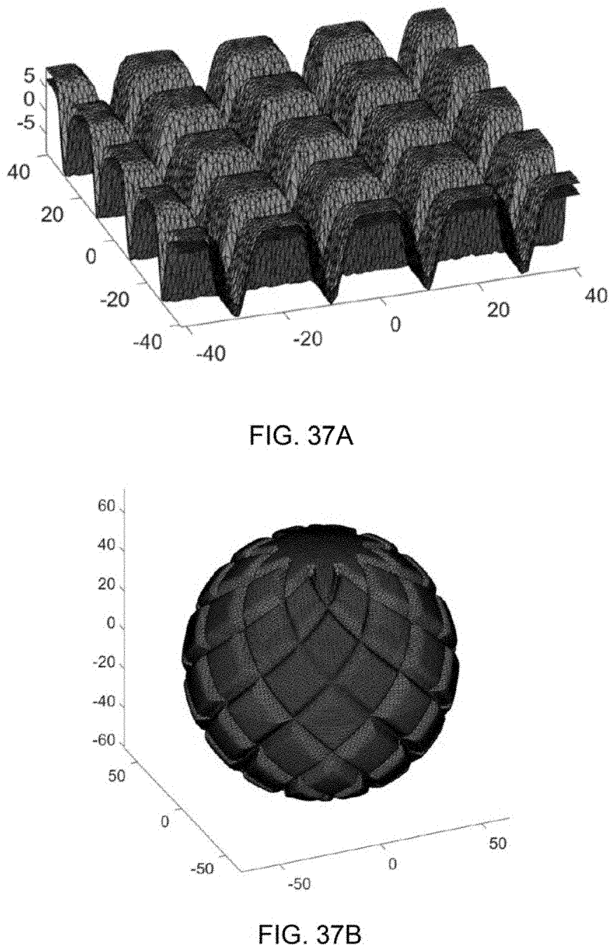

Validation has been performed using two phantoms designed to be as anatomically relevant as practical whilst using analytic functions (see FIGS. 37A-37B). The first, sines, is a function of the form

z=a−b(max(sin(fx)ⁿ,sin(gy)ⁿ)) (eq. 6)
where a and b determine the peaks and troughs of the gyri and sulci, f and g are spatial frequencies and n is set as a large positive and even value (20) in order to generate narrow sulci and broad-topped gyri. This function is applied on a at rectangular xy plane; two copies separated by 2.5 mm are created, representing the pial and white surfaces respectively.

The second test case, bumpy spheres, is the same function applied to azimuth and elevation in spherical polar coordinates to yield radius; the poles of the sphere are left smooth in order to suppress unrealistic features (a singularity and sharp edges would otherwise form). As the gyri follow lines of latitude and longitude, and hence align perfectly with the coordinate axes at various points, the substitutions u=θ−Ø and u=θ+Ø are made so the gyri spiral around the sphere in opposing directions. Two concentric spheres are generated; the inner a scaled down version of the outer with a peak separation distance of 2.5 mm in between. As the accuracy of any surface-based method is ultimately constrained by the quality of the surfaces provided, tests were run at both normal surface resolutions (˜0.85 mm mean node spacing) and high surface resolutions (˜0.4 mm) in order to provide to investigate the potential effect of surface resolution on accuracy of output. Each test case was then evaluated at voxel resolutions of [1: 0.4: 3.8] mm isotropic.

Errors were measured on voxel- and tissue-wise basis as the absolute difference to the true voxel tissue proportion: if a voxel is estimated to be 50% GM, and truth is 60%, the error is 0.1 irrespective of sign. Note that this definition means that each voxel maps to three separate error values, one for each tissue. Finally, results were masked to consider only those voxels identified by Toblerone as intersecting the cortical ribbon as by definition these are the voxels containing partial volumes. Ground truth PV estimates were established by numerical integration to a high degree of accuracy. These phantoms have also been used to facilitate a comparison with two other surface-based PV estimation techniques as detailed below.

5.1 Ribbon-Constrained Method

This method is an extension of the ribbon-constrained (RC) algorithm used within the Human Connectome Project's (HCP) fMRISurface pipeline [10]. Though the intended use is to map volumetric data onto the cortical surface in a cortex-aware manner, and not actual estimation of PVs, it can nevertheless be modified for this purpose and the author of the algorithm has provided assistance to this end [7]. The algorithm distinguishes only between volumes that lie interior to the cortical ribbon (GM) or exterior (both WM and CSF); distinguishing between the latter two tissues was not necessary for the original use case (mapping BOLD data onto the cortical surface).

Estimation is performed in a vertex-wise manner by connecting the outer edges of the pial surface triangles that use a given vertex to the same edges of the corresponding triangles of the white surface, forming polyhedra. Each nearby voxel is then subdivided into a number of subvoxels (for these tests, the subdivision factor was set as 2 (ceil(v) 1)+1, where v is the largest voxel dimension), the centre points of which are tested to determine if they lie within the polyhedron and hence the cortical ribbon. The GM PV is thus found by summing the intersection fraction of all vertices within each voxel (this is achieved by mapping the value 1 from each vertex into volume space with the HCP's wb command -metric-to-volume-mapping -ribbon-constrained; as the input data has unit value the output is simply the sum of intersection fractions in each voxel). WM and CSF estimates are obtained via a signed-distance method in which non-cortical volumes lying interior to the mid-thickness surface are labelled as WM and exterior as CSF; this in turn means that the non-cortical volume within an individual voxel is only ever assigned to one tissue class and not both at the same time and so the method is unable to identify a voxel in which all three tissues are present. Though such voxels are likely to be rare at structural resolution, this is not the case at functional resolution: testing on a real cortical surface and functional image of resolution [3.4 3.4 5] mm shows that 45% of voxels intersecting the cortical ribbon are three-class.

Accordingly, two variants of this method have been tested: “RC1”, direct estimation of PVs at arbitrary resolutions according to the above protocol; and “RC2”, estimation of PVs at structural resolution and then resampling to arbitrary resolutions via an integrative process (FSL's [11] applywarp tool with the super flag set and superlevel 4. The output of wb_command -convert-affine -to-flirt tool operating on an identity matrix was passed in as the -premat to applywarp to correct a known coordinate shift arising from FSL's handling of coordinate systems. Applywarp subsequently upsamples the image by a factor of 4 and downsamples to the desired resolution by integrating subvoxels at the higher resolution). Note that the results of RC1 and RC2 at structural resolution will be identical: no resampling is required.

5.2 NeuropolyPVE

This method [12] uses a voxelisation method based on the work of [13], itself similar to [9], applied in a brain-specific context and requiring fully contiguous surfaces (hence this method was not run on the sines test). The intended use is PV estimation at structural resolution; estimates at functional resolutions were obtained by the same integrative resampling process as used RC2 detailed above. Multiple expanded and contracted copies of each surface are made and the ratio of expanded to contracted surfaces intersecting a given voxel is used as a first approximation for partial volumes. Along with surface orientation information, this ratio is then mapped via trigonometric relations on the unit cube into a partial volume estimate (as a consequence, the estimates returned take discrete values in the unit interval).

6. Results and Discussion

Toblerone errors are lowest, or close to lowest, at all voxel resolutions, particularly so for WM and CSF. This is due to the fact that it quantifies all tissues directly at subvoxel resolution whereas the RC1 and RC2 methods cannot distinguish between WM and CSF within the same voxel. The errors for Toblerone remain broadly constant across the full range of voxel resolutions and surface resolutions. This shows both that Toblerone is suitable for use at a range of imaging resolutions and that, when operating at normal surface resolutions, surface resolution is not a limiting factor for the accuracy of PV estimates.

The accuracy of RC1 for GM estimates at all resolution is close to that of Toblerone but this is not so for RC2. As the core of the RC method is optimized for GM above all else, it is logical that it should perform better when estimating GM directly at any given resolution (RC1) than when estimating at one resolution and resampling to others (RC2) due to subvoxel effects (see paragraph below). There is, however, a clear advantage to using RC2 over RC1 for estimating WM and CSF at larger voxel resolutions due to the inability of the former to accurately process three-class voxels, but it is unclear where the crossover resolution (the point at which one method is better than the other) lies in general. For the sines test, it is in the range [1.8 2.2] mm, for the bumpy spheres, in the range [3 3.4] mm. Due to the nature of the Toblerone algorithm there is no such crossover point, which further reinforces the conclusion that it is suitable for use across a wide range of imaging resolutions.

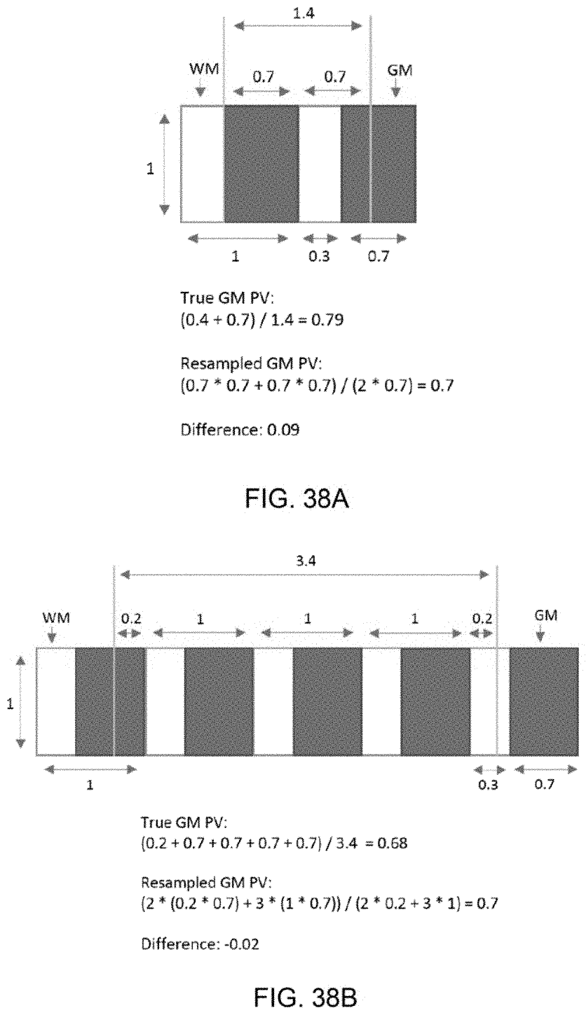

The worse performance of RC2 at lower resolutions is thought to be due to so-called subvoxel effects inherent to the resampling process. These may be thought of according to following situation (the argument is in 1D but translates easily). Consider a row of voxels at 1 mm resolution that are to be resampled to 1.4 mm. Imagine a voxel of size 1.4 mm that overlaps evenly with two of the smaller voxels, covering 0.7 mm of each. The PV estimates of this voxel will be taken as the mean of the two smaller, but in doing so, information about the spatial distributions of the tissues within the smaller voxels will be lost. Consider resampling to a larger resolution of 3.4 mm: the overlap onto smaller voxels may now be 0.2, 1, 1, 1, 0.2 mm. As the central three voxels are included wholly in the new voxel the loss of information regarding spatial distribution within them is unimportant; subvoxel effects are only important in two of the five voxels. Subvoxel effects are thus more significant at smaller resolutions. See FIGS. 38A-38B).

Finally, NeuropolyPVE performs worse than Toblerone and both RC methods at all voxel resolutions. This is presumably due to its approximate nature, and though the errors could likely be improved by increasing the number of surface copies generated (the default value of 5 was used for these tests) this would entail longer run times (though the actual estimation step is fast, the surface expansions are slow).

7. Conclusion

Toblerone is a reliable method for estimating partial volumes on the cortical ribbon at a range of voxel resolutions. It provides both fully continuous estimates and a high degree of accuracy, particularly for WM and CSF. Though it has been developed for use within functional brain imaging, the fact that the input surfaces do not need to have vertex correspondence or to be contiguous means that the method can be applied in other contexts. In practical usage, the accuracy of PV estimates from Toblerone will of course be constrained by the accuracy of the surfaces passed in, though the tests performed here show do at least show that surface resolution (distinct from accuracy) is not a limiting factor for the accuracy of estimates produced. Irrespective of whether the surfaces provided are accurate or not, Toblerone is demonstrably faithful to them and, given the recent interest in surface-based analysis of functional imaging and technological developments in MRI, there is reason to believe the accuracy of tools such as FreeSurfer will continue to improve in the future.

### REFERENCES

[1] B. Fischl and A. M. Dale, “Measuring the thickness of the human cerebral cortex from magnetic resonance images,” Proceedings of the National Academy of Sciences, vol. 97, pp. 11050 LP-11055, September 2000.
[2] M. Chappell and T. Okell, “Partial Volume Correction in Arterial Spin Labeling Perfusion MRI: A unique insight into physiology or an analysis step too far?,” vol. C.
[3] N. A. Johnson, G.-H. Jahng, M. W. Weiner, B. L. Miller, H. C. Chui, W. J. Jagust, M. L. Gorno-Tempini, and N. Schuff, “Pattern of Cerebral Hypoperfusion in Alzheimer Disease and Mild Cognitive Impairment Measured with Arterial Spin-labeling MR Imaging: Initial Experience,” Radiology, vol. 234, pp. 851-859, mar 2005.
[4] P. Santago and H. D. Gage, “Quantification of MR brain images by mixture density and partial volume modeling,” IEEE Transactions on Medical Imaging, vol. 12, no. 3, pp. 566-574, 1993.
[5] Y. Zhang, M. Brady, and S. Smith, ‘FSL Automatic Segmentation Tool (FAST),” 2001.
[6] Y. Zhang, M. Brady, and S. Smith, “Segmentation of brain MR images through a hidden Markov random field model and the expectation-maximization algorithm,” IEEE Transactions on Medical Imaging, vol. 20, no. 1, pp. 45-57, 2001.
[7] T. S. Coalson, D. C. V. Essen, and M. F. Glasser, “Lost in Space: The Impact of Traditional Neuroimaging Methods on the Spatial Localization of Cortical Areas,” no. September, pp. 1-31, 2017.
[8] B. Fischl, “FreeSurfer,” Neuroimage, vol. 62, no. 2, pp. 774-781, 2012.
[9] F. S. Nooruddin and G. Turk, “Simplification and repair of polygonal models using volumetric techniques,” IEEE Transactions on Visualization and Computer Graphics, vol. 9, no. 2, pp. 191{205, 2003.
[10] M. F. Glasser, S. N. Sotiropoulos, J. A. Wilson, T. S. Coalson, B. Fischl, J. L. Andersson, J. Xu, S. Jbabdi, M. Webster, J. R. Polimeni, D. C. Van Essen, and M. Jenkinson, “The minimal preprocessing pipelines for the Human Connectome Project,” NeuroImage, vol. 80, pp. 105-124, 2013.
[11] M. Jenkinson, C. F. Beckmann, T. E. J. Behrens, M. W. Woolrich, and S. M. Smith, “FSL.,” NeuroImage, vol. 62, pp. 782-790, August 2012.
[12] C. V. Assel, G. Mangeat, B. D. Leener, N. Stikov, C. Mainero, and J. Cohen, “Partial volume effect correction for surface-based cortical mapping,” pp. 5-7, 2017.
[13] S. Patil and B. Ravi, “Voxel-based representation, display and thickness analysis of intricate shapes,” Proceedings—Ninth International Conference on Computer Aided Design and Computer Graphics, CAD/CG 2005, vol. 2005, pp. 415-420, 2005.

Ratios, concentrations, amounts, and other numerical data may be expressed in a range format. It is to be understood that such a range format is used for convenience and brevity, and should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1% to about 5%, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figure of the numerical value. In addition, the phrase “about ‘x’ to ‘y’” includes “about ‘x’ to about ‘y’”.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Therefore, at least the following is claimed:

1. A method for image reconstruction, comprising:
providing or having provided surfaces derived from imaging data from a subject;
setting a reference grid comprised of a plurality of voxels within the imaging data;
mapping the surfaces into the reference grid;
identifying and recording local patches of the surfaces intersecting each voxel of the reference grid;
subdividing one or more of the voxels into one or more subvoxels by a first subdivision factor;
processing the one or more subvoxels to determine their partial volumes arising from intersection with at least one of the surfaces by assigning a class volume,
wherein assigning a class volume comprises determining if a subvoxel intersects at least one of the surfaces, wherein:
if it does not intersect at least one of the surfaces, assigning a single class volume, or
if the subvoxel intersects one of the surfaces, estimating an interior or exterior partial volume of the subvoxel and determining the estimated interior or exterior volume by subtracting the estimated volume from the total subdivided voxel volume, or
if the one of the surfaces is folded within the subvoxel or intersects the subvoxel more than once, then subdividing the subvoxel with a second subdivision factor and assigning a single tissue class volume to the subdivided subvoxel,
combining the partial volumes of each individual subvoxel and subdivided subvoxel; and
reconstructing an image from the combined partial volumes.

2. The method of claim 1, wherein the subject is a human subject.

3. The method of claim 1, wherein the imaging data is functional magnetic resonance data, arterial spin labeling (ASL) data, blood-oxygen level dependent magnetic resonance imaging (MRI) data, or positron emission tomography data.

4. The method of claim 2, wherein the imaging data is ASL data.

5. The method of claim 1, wherein estimating an interior or exterior partial volume of the subvoxel is with a convex hull and determining the estimated interior or exterior volume is with a non-convex hull by subtracting the convex hull estimated volume from the total subdivided voxel volume.

6. The method of claim 1, wherein the identifying and recording involves use of a separating axis theorem.

7. The method of claim 1, wherein the identifying and recording is with Moller's Box-overlap test.

8. The method of claim 1, wherein the first subdivision factor converts an anisotropic voxel to an isotropic voxel.

9. The method of claim 1, wherein the first subdivision factor is ceil (v/0.75) where v is the vector of voxel dimensions and 0.75 represents the lower limit of feature size found in the brain.

10. The method of claim 1, wherein the subject surface comprises one or more of white matter (WM), grey matter (GM), and cerebrospinal fluid (CSF).

11. The method of claim 1, wherein the second subdivision factor is 5.

12. The method of claim 1, further comprising acquiring the imaging data by providing a subject and positioning the subject in relation to an imaging scanner after providing the subject before providing the imaging data.

13. The method of claim 12, wherein the imaging scanner is a magnetic resonance imaging (MRI) or positron emission tomography (PET) scanner.

14. The method of claim 1, further comprising correcting the partial volumes.

15. The method of claim 14, wherein the correcting is performed using spatialVB.

16. The method of claim 1, further comprising outputting the reconstructed image to an imaging display.

17. A non-transitory computer readable medium comprising logic that, when executed on a computing device, executes the method of claim 1.

18. A system comprising an imaging scanner and at least one computing device in data communication with the imaging scanner; and an application executable in the at least one computing device, the application comprising logic that when executed on the computing device, executes the method of claim 1.

19. The system of claim 18, wherein the scanner is a magnetic resonance imaging scanner or positron emission tomography scanner.
